(19) United States
(12) Patent Application Publication
(10) Pub. No.: US 2015/0153830 A1
(43) Pub. Date: Jun. 4, 2015

(54) HAPTIC FEEDBACK DEVICE AND HAPTIC FEEDBACK METHOD

(71) Applicant: Panasonic Intellectual Property Management Co., Ltd., Osaka (JP)

(72) Inventors: Yoshifumi HIROSE, Kyoto (JP); Shoichi ARAKI, Osaka (JP)

(21) Appl. No.: 14/587,182

(22) Filed: Dec. 31, 2014

Related U.S. Application Data
(63) Continuation of application No. PCT/JP2013/006093, filed on Oct. 11, 2013.

(30) Foreign Application Priority Data
Nov. 30, 2012 (JP) 2012-263669

(51) Int. Cl. G06F 3/01; G06F 3/041

(52) U.S. Cl. CPC G06F 3/016; G06F 3/0416; G06F 2203/04104

(57) ABSTRACT

A haptic feedback device including a processor that derives touch information including at least one of state information indicating a state of a panel when a plurality of touches are detected or characteristic information indicating a characteristic of at least one of a plurality of objects touching the panel at a plurality of touch positions, and generates driving signals for driving a plurality of actuators to vibrate the panel according to a haptic signal at a first touch position and vibrate the panel at a second touch position more weakly than at the first touch position by using transfer functions of the panel which correspond to the touch information and are from each of the plurality of actuators to the first touch position and the second touch position.

### CROSS REFERENCE TO RELATED APPLICATIONS

This is a continuation application of PCT International Application No. PCT/JP2013/006093 filed on Oct. 11, 2013, designating the United States of America, which is based on and claims priority of Japanese Patent Application No. 2012-263669 filed on Nov. 30, 2012. The entire disclosures of the above-identified applications, including the specifications, drawings and claims are incorporated herein by reference in their entirety.

### FIELD

One or more exemplary embodiments disclosed herein relate generally to haptic feedback devices and haptic feedback methods for providing haptic feedback in response to an action performed on a touch panel by a user.

### BACKGROUND

Public terminals (for example, automated teller machines (ATM) and ticket vending machines) which include touch panels are conventionally known. The number of personal use devices (for example, tablet personal computers (PC) and smartphones) having touch panels is increasing.

Touch panels are input devices which detect touches made on the panel as inputs. Touch panels typically use a liquid crystal display or an organic electroluminescent (EL) display. These touch panels are often referred to as touch displays. For example, touch panels detect touches made by a user on a graphical user interface (GUI) object (a button, for example) displayed in the display region.

These kinds of user interfaces used in touch panels are advantageous in that they are highly adaptable in regard to the arrangement of GUI objects. However, with these user interfaces, touch panels provide less sensory feedback upon the press of a button compared to user interfaces using conventional, mechanical buttons. As such, these kinds of user interfaces are disadvantageous in that they can cause the user to be uncertain about whether a touch he or she made on the touch panel was correctly detected or not.

A method of providing haptic feedback for a touch made on a touch panel has been proposed (see Patent Literature (PTL) 1). PTL 1 discloses a method of providing haptic feedback for touches made on a touch panel capable of detecting multiple touches (hereinafter referred to as a multi-touch panel).

### CITATION LIST

### Patent Literature

[PTL 1] United States Patent Application Publication No. 2009/0250267

### Non Patent Literature

[NPTL 1] “Progress report on method of detecting level of press by contact area on FTIR touch panel” NAITO Masaki et al., Proceedings of the 71st National Convention of IPSJ; 2009 (4), “4-173”-“4-174”.

### SUMMARY

### Technical Problem

With the conventional technique described above, however, it may be difficult to provide suitable haptic feedback for multiple touches.

One non-limiting and exemplary embodiment provides a haptic feedback device capable of providing suitable haptic feedback for multiple touches.

### Solution to Problem

In one general aspect, the techniques disclosed here feature a haptic feedback device which provides haptic feedback to a user by vibrating a panel and includes: the panel; a detector that detects a plurality of touches in concurrent contact with the panel and detects a plurality of positions, on the panel, of the plurality of touches; a processor that derives touch information including at least one of state information indicating a state of the panel when the plurality of touches are detected or characteristic information indicating a characteristic of at least one of a plurality of objects touching the panel at the plurality of touch positions; determines, from among the plurality of touch positions, a first touch position at which to provide haptic feedback by vibration according to a predetermined haptic signal; and generates driving signals for driving the plurality of actuators to vibrate the panel according to the haptic signal at the first touch position and vibrate the panel at a second touch position included in the plurality of touch positions more weakly than at the first touch position by using transfer functions of the panel from each of the plurality of actuators to the first touch position and the second touch position, the transfer functions corresponding to the touch information, wherein the plurality of actuators vibrate the panel based on the driving signals.

General and specific aspect(s) disclosed above may be implemented using a system, a method, an integrated circuit, a computer program, or a computer-readable recording medium such as a CD-ROM, or any combination of systems, methods, integrated circuits, computer programs, or computer-readable recording media.

Additional benefits and advantages of the disclosed embodiments will be apparent from the Specification and Drawings. The benefits and/or advantages may be individually obtained by the various embodiments and features of the Specification and Drawings, which need not all be provided in order to obtain one or more of such benefits and/or advantages.

### Advantageous Effects

The haptic feedback device according to one or more exemplary embodiments or features disclosed herein provides suitable haptic feedback for multiple touches.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 illustrates the configuration of a conventional haptic feedback device.

FIG. 2 is a block diagram illustrating the functional configuration of the haptic feedback device according to Embodiment 1.

FIG. 3 illustrates one example of the structure of the haptic feedback device according to Embodiment 1.

FIG. 4 illustrates variations in the transfer function caused by load.

FIG. 5 illustrates the propagation paths of vibrations from an actuator to a position on the panel.

FIG. 6A illustrates one example of a TSP signal.

FIG. 6B illustrates one example of a TSP response.

FIG. 6C illustrates one example of the inverted function of a TSP signal.

FIG. 6D illustrates one example of an impulse response calculated from the TSP response.

FIG. 7 illustrates one example of transfer functions stored in the transfer function storage unit according to Embodiment 1.

FIG. 8A illustrates one example of the haptic signal stored in the haptic signal storage unit.

FIG. 8B illustrates one example of the haptic signal stored in the haptic signal storage unit.

FIG. 9 is a flow chart illustrating operations performed by the haptic feedback device according to Embodiment 1.

FIG. 10 is a diagram for illustrating the processes performed by the haptic feedback device according to Embodiment 1.

FIG. 11 illustrates a specific example of an image displayed on the panel according to Embodiment 1.

FIG. 12 illustrates examples of filters.

FIG. 13 illustrates examples of driving signals.

FIG. 14 illustrates an actual result of vibration imparted on the panel at each touch position according to Embodiment 1.

FIG. 15 illustrates an actual result of vibration imparted on the panel at each touch position according to a comparative example.

FIG. 16 shows one example of transfer functions stored in the transfer function storage unit according to Variation 2 of Embodiment 1.

FIG. 17 is a block diagram illustrating the functional configuration of the haptic feedback device according to Embodiment 2.

FIG. 18 illustrates one example of a transfer function obtained by interpolation.

FIG. 19 illustrates one example of a transfer function obtained by interpolation per frequency.

FIG. 20 is a flow chart illustrating operations performed by the haptic feedback device according to Embodiment 2.

FIG. 21 is a block diagram illustrating the functional configuration of the haptic feedback device according to an embodiment.

FIG. 22 is a flow chart illustrating operations performed by the haptic feedback device according to an embodiment.

### DESCRIPTION OF EMBODIMENTS

In the present description, “multiple touches” refers to a plurality of touches in concurrent contact with the panel. In other words, “multiple touches” means a plurality of touches which all contact the panel at a given point in time. To further clarify, multiple touches are a plurality of temporally overlapping touches made at a plurality of positions on the panel. As such, multiple touches not only include a plurality of touches initiated at the same time, but also touches initiated at different times which are detected at the same time, at some point in time. More specifically, when a first touch is initiated and held and then a second touch is initiated, the first touch and the second touch are “multiple touches” at the point in time of the initiation of the second touch.

(Underlying Knowledge Forming Basis of the Present Disclosure)

It is possible for more than one user to perform actions at the same time on a multi-touch panel. Also, a user is capable of intuitively enlarging or rotating a target object, for example, by performing an action using more than one finger on a multi-touch panel. With such a multi-touch panel where haptic feedback is provided for multiple touches, it is desirable to provide haptic feedback which can be discriminated for each touch.

Typically, when only one actuator is used to provide haptic feedback at two or more touch positions at the same time, a similar type of haptic feedback is provided at each of the touch positions at the same time. Moreover, with only one actuator, it is difficult to provide haptic feedback at only a given one of two or more touch positions.

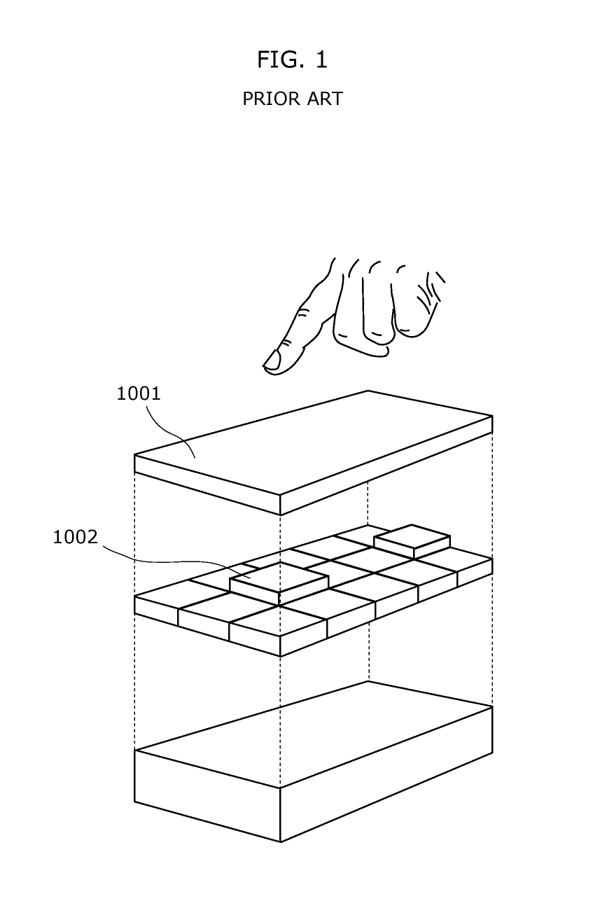

In light of this, the touch panel disclosed in PTL 1 includes an array of actuators 1002 disposed below a flexible surface layer 1001. Each of the actuators 1002 can be independently raised and lowered up and down, as is illustrated in FIG. 1. Distinguishable haptic feedback is provided for multiple touches by independently raising a plurality of the actuators 1002 located below a touch position.

In this way, with the method disclosed in PTL 1, it is possible to provide different haptic feedback at a plurality of touch positions at the same time by disposing an array of actuators 1002 below the surface layer 1001. However, in order to provide haptic feedback at a given position on the surface layer 1001, it is necessary to provide the actuators 1002 in units as small as or smaller than the resolution of a human finger (approximately 10 mm to 20 mm). As such, with the method disclosed in PTL 1, provision of an extremely large number of actuators is required.

Moreover, in order to make it possible to directly touch a GUI object (such as a button) displayed on the screen, provision of a display apparatus, such as a liquid crystal display, below the actuators 1002 is required. This consequently requires the actuators 1002 to be transparent. However, such transparent actuators are difficult to employ in touch panels.

Therefore, to provide different haptic feedback at a plurality of touch positions at the same time, one conceivable method is to control a plurality of actuators positioned at the periphery of the panel based on transfer functions of the panel between the plurality of touch positions and the plurality of actuators. For example, each actuator can be controlled to vibrate the panel such that a position where haptic feedback is intended to be provided is an antinode and a position where haptic feedback is not intended to be provided is a node.

However, in this case, since the user is touching the panel, a load is applied to the touch position by the touch. Consequently, the system of the vibration of the panel from each actuator to each touch position changes compared to when a load is not applied to the touch position. In other words, the transfer functions of the panel vary depending on the touch made. Providing suitable haptic feedback for multiple touches is difficult if this variation in the transfer functions of the panel is not taken into account when controlling the actuators. For example, if the actuators are controlled based on transfer functions without taking into account the load applied to the panel by a touch, there are times when haptic feedback is provided at touch positions where haptic feedback is not intended to be provided.

In one aspect of the present disclosure, a haptic feedback device which provides haptic feedback to a user by vibrating a panel includes: the panel; a plurality of actuators placed at mutually different positions on the panel for vibrating the panel; a detector that detects a plurality of touches in concurrent contact with the panel and detects a plurality of positions, on the panel, of the plurality of touches; a processor that derives touch information including at least one of state information indicating a state of the panel when the plurality of touches are detected or characteristic information indicating a characteristic of at least one of a plurality of objects touching the panel at the plurality of touch positions; determines, from among the plurality of touch positions, a first touch position at which to provide haptic feedback by vibration according to a predetermined haptic signal; and generates driving signals for driving the plurality of actuators to vibrate the panel according to the haptic signal at the first touch position and vibrate the panel at a second touch position included in the plurality of touch positions more weakly than at the first touch position by using transfer functions of the panel from each of the plurality of actuators to the first touch position and the second touch position, the transfer functions corresponding to the touch information, wherein the plurality of actuators vibrate the panel based on the driving signals.

With this configuration, it is possible to obtain driving signals generated (generate driving signals) using transfer functions of the panel which correspond to the touch information. Consequently, it possible to adjust for variations in the transfer functions of the panel caused by touches and vibrate the panel accordingly, and thus possible to provide suitable haptic feedback for the multiple touches. More specifically, it is possible to vibrate the panel at the first touch position based on the haptic signal, and keep vibration of the panel at the second touch position less than at the first touch position. For example, it is possible to cause the vibration amplitude of the panel at the second touch position to be of a magnitude that is undetectable as haptic sensation by humans (for example, 1 μm or less). In this case, it is possible to provide haptic feedback at the first touch position and provide virtually no haptic feedback at the second touch position.

Moreover, with this configuration, the driving signals for driving each of the actuators are signals generated using transfer functions. As such, even if the first touch position and the actuator are not located close to each other, it is possible to impart vibration at the first touch position and not impart vibration at the second touch position. In other words, since it is not necessary to provide a multitude of actuators below the panel, it is possible to efficiently provide haptic feedback for multiple touches. Furthermore, even in cases where a display apparatus is provided below the panel, provision of transparent actuators is not required, making it possible to relatively simply manufacture the haptic feedback device.

For example, the touch information may include load information indicating at least one of a plurality of loads applied to the panel at the plurality of touch positions.

With this configuration, it is possible to obtain (derive) the touch information which includes load information indicating at least one of a plurality of loads applied to the panel at the plurality of touch positions. As such, the panel can be vibrated using driving signals generated using transfer functions of the panel that correspond to loads which alter the transfer functions of the panel, thereby making it possible to provide even more suitable haptic feedback.

For example, the touch information may include contact surface area information indicating at least one of a plurality of contact surface areas between the panel and the plurality of objects at the plurality of touch positions.

With this configuration, it is possible to obtain (derive) the touch information which includes contact surface area information indicating at least one of a plurality of contact surface areas between the panel and the plurality of objects at the plurality of touch positions. As such, the panel can be vibrated using driving signals generated using transfer functions of the panel that correspond to contact surface areas which alter the transfer functions of the panel, thereby making it possible to provide even more suitable haptic feedback.

For example, the touch information may include hardness information indicating hardness of at least one of the plurality of objects touching the panel at the plurality of touch positions.

With this configuration, it is possible to obtain (derive) the touch information which includes hardness information indicating hardness of at least one of the plurality of objects touching the panel at the plurality of touch positions. As such, the panel can be vibrated using driving signals generated using transfer functions of the panel that correspond to the hardness of the input object, which alters the transfer functions of the panel, thereby making it possible to provide even more suitable haptic feedback.

For example, the processor may further generate filters for filtering a given haptic signal to generate driving signals for driving the plurality of actuators to vibrate the panel at the first touch position according to the given haptic signal and not vibrate the panel at the second touch position by using the transfer functions, wherein the driving signals are generated by filtering the haptic signal with the filters.

With this configuration, it is possible to generate driving signals by filtering the haptic signal using filters. These filters are used on a given haptic signal. In other words, with respect to the generation of one driving signal, a common filter can be used for a plurality of haptic signals, thereby reducing the load for generating the driving signals.

For example, the filters may be generated so that a sum of convolution results, in a time domain, of first transfer functions included in the transfer functions and the filters indicates an impulse, and a sum of convolution results, in the time domain, of second transfer functions included in the transfer functions and the filters indicates zero, the first transfer functions indicating the transfer functions from each of the plurality of actuators to the first touch position and the second transfer functions indicating the transfer functions from each of the plurality of actuators to the second touch position.

With this configuration, it is possible to calculate (generate) filters in the time domain.

For example, the filters may be generated so that a sum of products, in a frequency domain, of first transfer functions included in the transfer functions and the filters indicates an impulse, and a sum of products, in the frequency domain, of second transfer functions included in the transfer functions and the filters indicates zero, the first transfer functions indicating the transfer functions from each of the plurality of actuators to the first touch position and the second transfer functions indicating the transfer functions from each of the plurality of actuators to the second touch position.

With this configuration, it is possible to calculate (generate) filters in the frequency domain. In other words, it is possible to reduce the processing load more so than when the filters are calculated in the time domain.

For example, the filters may be generated by using the transfer functions corresponding to information associated with the second touch position among the touch information.

With this configuration, it is possible to calculate (generate) filters using transfer functions corresponding to information associated with a second touch position among the touch information. As such, since it is not necessary to obtain a transfer function corresponding to a combination of information on the first touch position and information on the second touch position, it is possible to reduce the number of transfer functions required to be stored in advance. In other words, it is possible to reduce the storage space required to store the transfer functions. Moreover, vibration of the panel at the second touch position can be minimized more so than when transfer functions corresponding to information on the first touch position are used, making it possible to provide even more suitable haptic feedback.

For example, the processor may further: derive a plurality of transfer functions respectively corresponding to a plurality of pieces of touch information similar to the derived touch information; interpolate a transfer function corresponding to the derived touch information using the plurality of derived transfer functions; and calculate the filters using the interpolated transfer function.

With this configuration, it is possible to interpolate a transfer function corresponding to obtained (derived) touch information using the plurality of transfer functions respectively corresponding to a plurality of pieces of touch information similar to the obtained touch information. Consequently, when the haptic feedback device cannot obtain a transfer function corresponding to obtained touch information, it is possible to obtain a transfer function suitable for the obtained touch information by interpolation. In other words, since it is possible to obtain a more accurate transfer function, it is possible to provide even more suitable haptic feedback. Moreover, it is possible to reduce the number of transfer functions stored in advance, thereby making it possible to reduce the storage space required to store the transfer functions.

For example, the interpolated transfer function may be interpolated using a linear combination of the plurality of derived transfer functions.

For example, the interpolated transfer function may be interpolated by performing polynomial approximation using (i) an amplitude and a phase of each frequency in the plurality of derived transfer functions and (ii) the plurality of pieces of touch information similar to the derived touch information.

General and specific aspect(s) disclosed above may be implemented using a system, a method, an integrated circuit, a computer program, or a computer-readable recording medium such as a CD-ROM, or any combination of systems, methods, integrated circuits, computer programs, or computer-readable recording media.

Hereinafter, embodiments are described with reference to the drawings.

Each embodiment described below shows a general or specific example. The numerical values, shapes, materials, structural components, the arrangement and connection of the structural components, steps, the processing order of the steps etc, shown in the following embodiments are mere examples, and therefore do not limit the scope of the Claims. Therefore, among the structural components in the following embodiments, structural components not recited in any one of the independent claims are described as arbitrary structural components.

### Embodiment 1

### Haptic Feedback Device Configuration

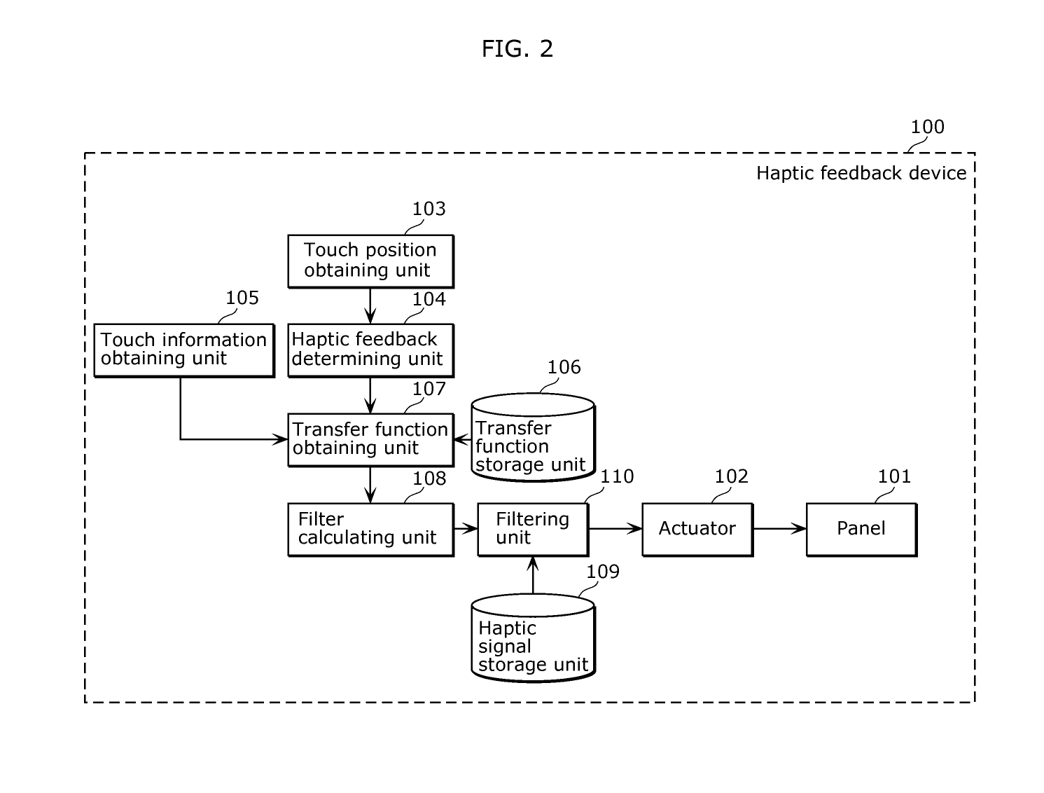

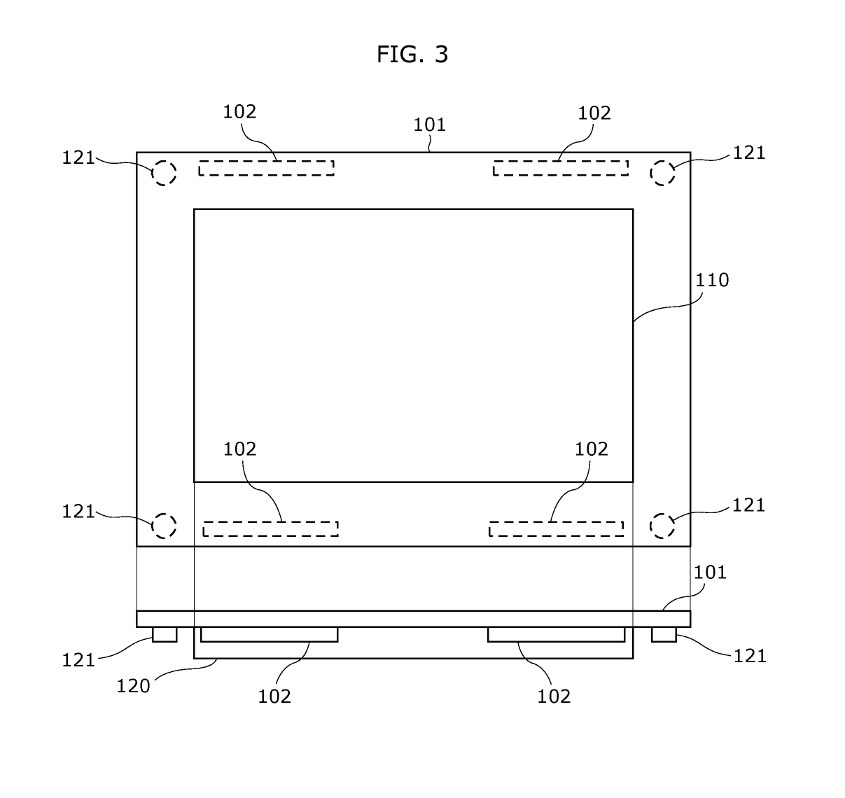

FIG. 2 illustrates the functional configuration of haptic feedback device 100 according to Embodiment 1. FIG. 3 illustrates an example of the structure of the haptic feedback device 100 according to Embodiment 1. The haptic feedback device 100 provides haptic feedback by vibrating panel 101.

As is illustrated in FIG. 2, the haptic feedback device 100 includes the panel 101, a plurality of actuators 102, a touch position obtaining unit (detector) 103, a haptic feedback determining unit (processor) 104, a touch information obtaining unit (processor) 105, a transfer function storage unit 106, a transfer function obtaining unit (processor) 107, a filter calculating unit (processor) 108, a haptic signal storage unit 109, and a filtering unit 110. Next, each structural component of the haptic feedback device 100 will be described.

(Panel 101)

The panel 101 transmits vibrations for providing haptic feedback. More specifically, the panel 101 is a flat component having light-transferring properties that is made of glass or acrylic, for example.

It should be noted that the shape, size, thickness, hardness, and fixing method of the panel 101 are not limited to any particular example. However, the transfer functions from the actuators 102 to each position (hereinafter also referred to as point) on the panel 101 vary depending on the shape, size, thickness, hardness, and fixing method of the panel 101.

It should be noted that a graphical user interface (GUI) can be realized by providing a display apparatus 120, such as a liquid crystal display or an organic EL display, behind the panel 101.

(Actuators 102)

The plurality of actuators 102 are provided in mutually different positions on the panel 101. For example, as is illustrated in FIG. 3, the plurality of actuators 102 are attached to the edges of the panel 101. In other words, the plurality of actuators 102 are provided outside of the region in which images are displayed on the panel 101.

Each actuator 102 vibrates the panel 101 according to a driving signal. In this way, haptic feedback is provided to a user by propagation of vibrations imparted to the panel 101 by each actuator 102 to a touch position on the panel 101.

In Embodiment 1, the number of actuators 102 is, for example, equal to or greater than the number of touches that the touch position obtaining unit 103 is capable of detecting at once. This allows the haptic feedback device 100 to provide mutually different haptic feedback for the number of detectable touch positions. Note that the number of actuators 102 is not required to be the number of touches capable of being detected at once; the number of actuators 102 may be less than the number of touches capable of being detected at once. In this case, the haptic feedback device 100 can control the haptics at as many touch positions as there are actuators 102 from among a plurality of touch positions.

The actuators 102 may be, for example, piezoelectric elements (piezo elements). Alternatively, the actuators 102 may be voice coils. Furthermore, the actuators 102 may include an amplifier for amplifying the driving signal. It should be noted that the type of actuator 102 used is not particularly limited either.

The spacing of the actuators 102 is not particularly limited. For example, a plurality of the actuators 102 may be arranged to facilitate efficient vibration of the panel 101.

(Touch Position Obtaining Unit 103)

The touch position obtaining unit 103 obtains a plurality of touch positions on the panel 101 by detecting a plurality of touches (multiple touches) in concurrent contact with the panel 101 (that is, detects a plurality of touches (multiple touches) in concurrent contact with the panel 101 and detects a plurality of positions, on the panel 101, of the plurality of touches). In other words, the touch position obtaining unit 103 obtains a plurality of touch positions on the panel 101 by detecting multiple touches made by the user on the panel 101. For example, the touch position obtaining unit 103 obtains coordinates for a plurality of touch positions.

The touch position obtaining unit 103 is, for example, an electrostatic capacitive multi-touch panel or a pressure sensitive multi-touch panel. When, for example, the touch position obtaining unit 103 is an electrostatic capacitive multi-touch panel, the touch position obtaining unit 103 obtains a plurality of touch positions based on changes in electrostatic capacitance caused by the multiple touches. When, for example, the touch position obtaining unit 103 is a pressure sensitive mufti-touch panel, the touch position obtaining unit 103 obtains a plurality of touch positions based on changes in pressure caused by the multiple touches.

It should be noted that it is not necessary to limit the multi-touch panel to an electrostatic capacitive multi-touch panel or a pressure sensitive multi-touch panel. In other words, as long as the multi-touch panel is capable of detecting multiple touches, any type of multi-touch panel may be used.

It should be noted that when the touch position obtaining unit 103 is employed as a multi-touch panel, the multi-touch panel including the panel 101 and the touch position obtaining unit 103 may be integrated as a single component. For example, the touch position obtaining unit 103 and the panel 101 may be formed as a single component by bonding an electrostatic capacitative multi-touch panel to the panel 101.

Moreover, as is illustrated in FIG. 3, the display apparatus 120, which is, for example, a liquid crystal display or an organic EL display, may be provided behind the panel 101 or the touch position obtaining unit 103. This allows the haptic feedback device 100 to function as a touch display. It should be noted that provision of the display apparatus 120 is not absolutely necessary.

It should be noted that the plurality of touch positions on the panel 101 include positions touched directly on the panel 101 by the user as well as positions touched on the panel 101 by the user with, for example, a pen.

(Haptic Feedback Determining Unit 104)

The haptic feedback determining unit 104 determines, from among a plurality of touch positions, a first touch position (hereinafter also referred to as feedback position) at which haptic feedback is to be provided using a vibration according to a predetermined haptic signal. The haptic feedback determining unit 104 further determines at least one second touch position (hereinafter also referred to as a non-feedback position) at which haptic feedback is not to be provided using vibration according to a haptic signal.

More specifically, the haptic feedback determining unit 104, for example, determines one feedback position from among the plurality of touch positions based on the display position of GUI objects, loads at the touch positions, or the temporal or spatial relationship between the plurality of touch positions. Moreover, the haptic feedback determining unit 104 determines the touch positions other than the feedback position among the plurality of touch positions to be non-feedback positions. It should be noted that the method of determining the feedback position is not particularly limited to a specific example.

(Touch Information Obtaining Unit 105)

The touch information obtaining unit 105 obtains (derives) touch information. Touch information includes at least one of information indicating a state of the panel 101 when a plurality of touches are detected (state information) or information indicating a characteristic of at least one of a plurality of input objects (characteristic information). The input object is an object that contacts the panel 101 at a touch position. More specifically, the input object is, for example, the user's finger or a stylus pen.

The state of the panel 101 refers to, for example, the load applied to the panel 101 by a touch, the contact surface area between the panel 101 and the input object, the temperature of the panel 101, or the orientation of the panel 101. Moreover, the characteristic of the input object refers to, for example, the hardness, shape, size, or vibration characteristics of the input object. The transfer functions of the panel 101 vary depending on these characteristics of the input object and states of the panel 101.

For example, the touch information obtaining unit 105 may obtain touch information including load information indicating at least one of a plurality of loads applied to the panel 101 at the plurality of touch positions. Moreover, for example, the touch information obtaining unit 105 may obtain touch information including contact surface area information indicating at least one of a plurality of contact surface areas between and the plurality of input objects and the panel 101 at the plurality of touch positions. Moreover, for example, the touch information obtaining unit 105 may obtain touch information including hardness information indicating the hardness of at least one of the plurality of input objects touching the plurality of touch positions.

In other words, the touch information may include at least one of the load information, contact surface area information, or hardness information. In other words, the touch information may include one or any arbitrary combination of the load information, contact surface area information, and hardness information.

Next, a specific example will be given of the configuration of the touch information obtaining unit 105 when the touch information obtaining unit 105 obtains touch information including load information. For example, as is illustrated in FIG. 3, the touch information obtaining unit 105 uses output values from load sensors 121 provided at the four corners of the back surface of the panel 101 to estimate the load applied to each touch position. Here, the method of estimating the load at each touch position using the load sensors 121 will be described.

First, the method will be described in the case that there is one touch position. The output value Sⱼ of each load sensor varies depending on the touch position Pᵢ and the load Wᵢ applied to the touch position Pᵢ. Equation 1 for calculating the output value Sⱼ of each load sensor can be derived by approximating the effect on the touch position Pᵢ by linear regression.

$$\begin{matrix}[ Math 1 ] & \\ {S}_{j} = {W}_{i} [ \begin{matrix}{a}_{j 1} & {a}_{j 2} & {a}_{j 3}\end{matrix} ] [ \begin{matrix}{p}_{i}^{x} \\ {p}_{i}^{y} \\ 1\end{matrix} ] = {W}_{i} {A}_{j} {P}_{i} & ( Equation 1 )\end{matrix}$$

In Equation 1, p^{x}ᵢ indicates the X axis coordinate for the touch position Pᵢ, p^{y}ᵢ indicates the Y axis coordinate for the touch position Pᵢ, and Aⱼ=[aⱼ₁ aⱼ₂ aⱼ₃] indicates the regression coefficient.

With this, when there is a single touch position, the load Wᵢ at the touch position Pᵢ is estimated as illustrated by Equation 2, using the output value Sⱼ of the load sensor, the touch position Pᵢ, and the coefficient Aⱼ.

$$\begin{matrix}[ Math 2 ] & \\ {W}_{i} = \frac{{S}_{j}}{{A}_{j} {P}_{i}} & ( Equation 2 )\end{matrix}$$

Next, the calculation method will be described in the case that there are two or more touch positions. When coefficient Cⱼᵢ represents the effect the load applied to the touch position Pᵢ has on the output value Sⱼ of the load sensor, the coefficient Cⱼᵢ can be expressed as illustrated by Equation 3.

$$\begin{matrix}[ Math 3 ] & \\ {C}_{ji} = [ \begin{matrix}{a}_{j 1} & {a}_{j 2} & {a}_{j 3}\end{matrix} ] [ \begin{matrix}{p}_{i}^{x} \\ {p}_{i}^{y} \\ 1\end{matrix} ] & ( Equation 3 )\end{matrix}$$

Since the output value Sⱼ of each load sensor can be expressed as the sum of the effects the loads have on the plurality of touch positions Pᵢ, it can be expressed as illustrated by Equation 4.

$$\begin{matrix}[ Math 4 ] & \\ [ \begin{matrix}{S}_{1} \\ ⋮ \\ {S}_{M}\end{matrix} ] = [ \begin{matrix}{C}_{11} & … & {C}_{1 N} \\ ⋮ & ⋱ & ⋮ \\ {C}_{M 1} & … & {C}_{MN}\end{matrix} ] [ \begin{matrix}{W}_{1} \\ ⋮ \\ {W}_{N}\end{matrix} ] \\ S = CW & ( Equation 4 )\end{matrix}$$

When C* represents a generalized inverse matrix of coefficient matrix C, the load Wᵢ of each touch position Pᵢ can be calculated with Equation 5.

$$\begin{matrix}[ Math 5 ] & \\ [ \begin{matrix}{W}_{1} \\ ⋮ \\ {W}_{N}\end{matrix} ] = {C}^{*} [ \begin{matrix}{S}_{1} \\ ⋮ \\ {S}_{M}\end{matrix} ] & ( Equation 5 )\end{matrix}$$

It should be noted that in Equation 5, the load Wᵢ can be calculated when M≧N.

With this method, the touch information obtaining unit 105 can estimate the load at each touch position using the load sensors 121 disposed at the periphery of the panel 101.

When contact surface area information indicating the contact surface area of a touch made at the touch position is obtained as the touch information, the touch information obtaining unit 105, for example, obtains the contact surface area at each touch position using an infrared touch panel. The contact surface area at the touch position and the pressure at the time of the touch can be estimated with an infrared touch panel (see NPTL 1).

It should be noted that the touch information obtaining unit 105 may estimate the load at each touch position based on the contact surface area and the pressure at each touch position obtained using an infrared touch panel in this way.

When hardness information indicating the hardness of the input object is obtained as the touch information, the touch information obtaining unit 105, for example, estimates the hardness of the input object using the vibration frequency of the panel 101 when the input object touches the panel 101. Generally, the greater the vibration frequency of the panel 101 caused by the impact of a touch, the harder the input object is.

Here, for example, the hardness of the input object is expressed using a value indicating how hard the input object is compared to the pad of the user's finger (in other words, the part of the finger where the finger print is). More specifically, for example, the hardness of the input object is expressed as a ratio of the vibration frequency of the panel 101 when touched by the input object to the vibration frequency of the panel 101 when touched by the pad of the user's finger (premeasured vibration frequency). In this case, when the input object is an object harder than the pad of the user's finger (for example, when the input object is a stylus pen), the value indicating the hardness of the input object is greater than one. On the other hand, when the input object is an object softer than the pad of the user's finger, the value indicating the hardness of the input object is less than one.

It should be noted that in addition to the load information, contact surface area, or hardness information, the touch information obtaining unit 105 may obtain touch information including temperature information indicating the temperature of the panel 101 or orientation information indicating the orientation of the panel 101. The orientation of the panel 101 is expressed as the slope of the panel 101 relative to a reference plane (for example, a horizontal plane). In other words, the touch information may include temperature information or orientation information.

If the temperature of the panel 101 changes, so do the vibration characteristics of the panel 101. In other words, the vibration characteristics of the panel 101 vary depending on the temperature of the panel 101. Moreover, the vibration characteristics of the panel 101 when the panel 101 is parallel to the horizontal plane are different from when the panel 101 is vertical to the horizontal plane. In other words, the vibration characteristics of the panel 101 vary depending on the orientation of the panel 101.

When the touch information includes temperature information, the touch information obtaining unit 105 may obtain the temperature information for the panel 101 from, for example, a temperature sensor disposed on the bottom surface of the panel 101. Moreover, when the touch information includes orientation information, the touch information obtaining unit 105 may obtain the orientation information for the panel 101 from, for example, a gyro sensor disposed on the bottom surface of the panel 101.

(Transfer Function Storage Unit 106)

The transfer function storage unit 106 is, for example, a hard disk or semiconductor memory. For each piece of touch information, the transfer function storage unit 106 stores a transfer function from each actuator 102 to each point on the panel 101. In other words, the transfer function storage unit 106 stores transfer functions corresponding to combinations of positions on the panel 101, the actuators 102, and the touch information.

A transfer function indicates an input/output relationship in the system. Here, the driving signal of the actuator corresponds to the input, and the vibration at one point on the panel corresponds to the output. Generally, the transfer function G(ω) is expressed as a ratio of an input X(ω) to the system to an output Y(ω) from the system (G(ω)=Y(ω)/X(ω)). For example, when the input X(ω) is an impulse (X(ω)=1), the transfer function G(ω) is equal to the output Y(ω) (impulse response).

Next, the relationship between the transfer function and the touch position and touch information will be described.

The region of panel 101 in the vicinity of the actuator 102 vibrates as a result of the actuator 102 being driven. The vibration in the region of the panel 101 in the vicinity of the actuator 102 then propagates through the panel 101 to the feedback position. As a result, the haptic feedback device 100 is capable of providing haptic feedback to the user at the feedback position.

However, when the user is touching the panel 101, the vibration propagating through the panel 101 is affected by the touch. As such, the system of the vibration from the actuator 102 to the touch position is different from when the user is not touching the panel 101. In other words, the transfer functions of the panel 101 vary depending on the load or contact surface area at the touch position.

Consequently, in order to provide suitable haptic feedback to the user, use of transfer functions which take into account the effect touches have on the transfer functions of the panel 101 is desirable, in other words, the transfer functions are, for example, desirably stored for each piece of load information, contact surface area information, or hardness information.

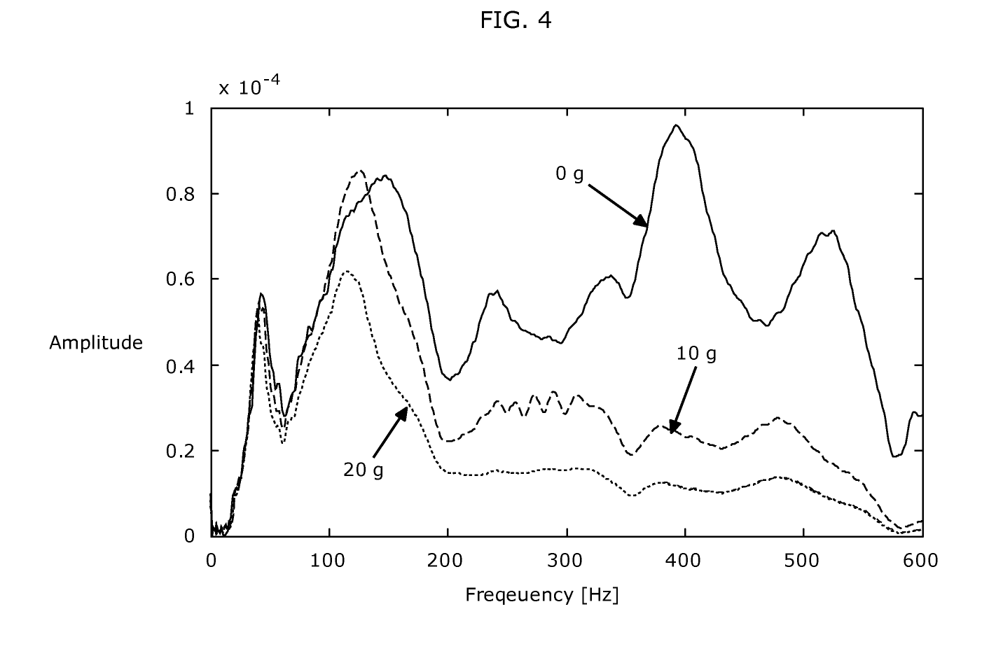

Next, the relationship between the load applied to the panel 101 and the transfer functions will be described with reference to FIG. 4. FIG. 4 illustrates the relationship between load applied to the panel 101 and transfer functions. In the graph in FIG. 4, load applied to the panel 101 is expressed as weight of an object set on the panel 101.

It can be understood from FIG. 4 that the transfer function while no load is applied to the panel 101 (weight: 0 g) is different from the transfer function while load is applied to the panel 11 (weight: 10 g or 20 g). More specifically, FIG. 4 illustrates that the frequency at the peak amplitude when the weight is 10 g is less than the frequency at the peak amplitude when the weight is 0 g. Moreover, FIG. 4 illustrates that the frequency at the peak amplitude when the weight is 20 g is less than the frequency at the peak amplitude when the weight is 10 g. In other words, the greater the load applied to the panel 101, the lower the peak frequency is.

Furthermore, FIG. 4 illustrates that in the frequency band of 200 Hz and higher, the amplitude while load is not applied to the panel 101 is greater than the amplitude while load is applied to the panel 101. In other words, the greater the load applied to the panel 101, the lower the amplitude is. Consequently, the transfer functions of the panel 101 vary depending on the load applied to the panel 101.

As such, in Embodiment 1, for each piece of touch information (for example, for each load value), the transfer function storage unit 106 stores an impulse response from each actuator 102 to each point on the panel 101 as a transfer function. It should be noted that the impulse responses may be expressed in the time domain, and alternatively may be expressed in the frequency domain. In other words, a temporal waveform of the impulse responses may be stored in the transfer function storage unit 106, and alternatively a spectrum of the impulse responses may be stored in the transfer function storage unit 105.

Here, each point on the panel 101 may be, for example, a representative point for each of segmented regions on the panel 101 (for example, a center point or a center of gravity). The segmented regions are, for example, obtained by segmenting the region of the panel 101 into 10 mm unit blocks with a grid. It should be noted that the shape of the segmented regions is not required to be rectangular, and may be a different shape. Moreover, the segmented regions are not required to have a uniform size. For example, the size of a segmented region may differ depending on its position on the panel 101.

Here, the smaller each segmented region is (in other words, the greater the number of segmented regions there are), the greater the resolution capability of haptic feedback becomes, but the greater the storage space required to store the transfer functions becomes.

In other words, since the resolution capability and the storage capacity have a trade off relationship, the size of each segmented region may be determined based on the resolution capability required or the storage space allocated. Next, the transfer functions stored in the transfer function storage unit 106 will be explained in further detail.

Here, the transfer function storage unit 106 will be explained under the pretense that it stores, for each piece of touch information, M×N transfer functions from each of M (M being an integer of 2 or more) actuators 102 (A₁, A₂, . . . , A_{M}) to each of N (N being an integer of 2 or more) positions on the panel 101 (P₁(x₁, y₁), P₂(x₂, y₂), . . . , P_{N}(x_{N}, y_{N})).

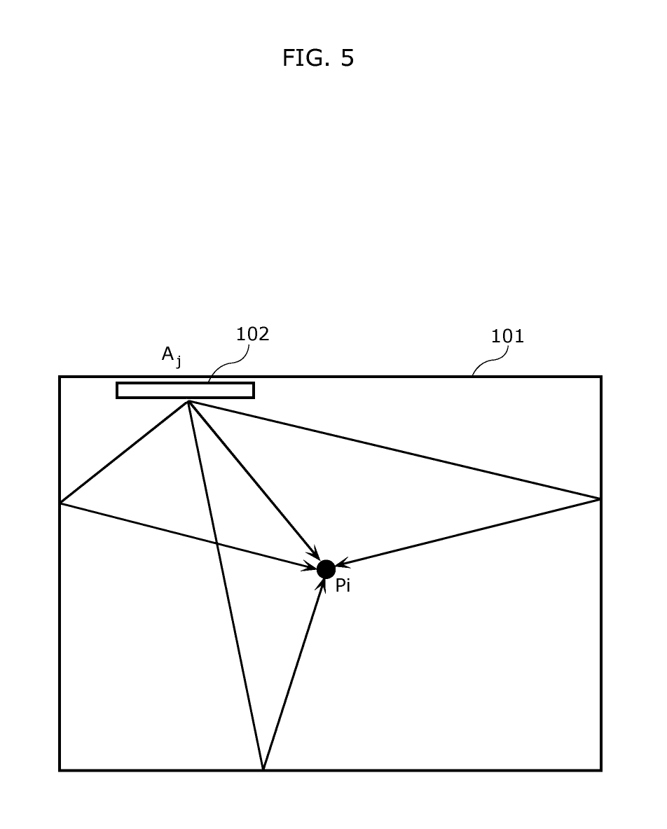

FIG. 5 illustrates the propagation paths of vibrations from an actuator 102 to a given position on the panel 101.

As is illustrated in FIG. 5, the vibration at position Pᵢ is a composite of a vibration arriving directly at the position Pᵢ(xᵢ, yᵢ) from the actuator Aⱼ and vibrations reflecting off the edges of the panel 101 before arriving at the position Pᵢ(xᵢ, yᵢ). As such, the transfer function includes a propagation characteristic of every path on the panel from the actuator Aⱼ to the position Pᵢ.

It should be noted that the transfer functions may be represented in the time domain, and alternatively may be represented in the frequency domain. As information, transfer functions represented in the time domain and transfer functions represented in the frequency domain are identical, and one can be converted into the other.

The transfer function from the actuator Aⱼ to the position Pᵢ(xᵢ, yᵢ) can be obtained by measuring the vibration (impulse response) at the position Pᵢ(xᵢ, yᵢ) when an impulse is inputted to the actuator Aⱼ, for example. The impulse response can completely represent the characteristics of the system from the actuator Aⱼ to the position Pᵢ(xᵢ, yᵢ). As such, in Embodiment 1, it is possible to use an impulse response as the transfer function.

It should be noted that typically, when an impulse is directly applied, since the continuance of the impulse is extremely short, the S/N ratio of the impulse response tends to reduce. As such, the impulse response may be measured using the time stretched pulse (TSP) instead of the impulse. With this, it is possible to obtain an impulse response having a high S/N ratio as the transfer function. Next, a method of measuring the impulse response using TSP will be described.

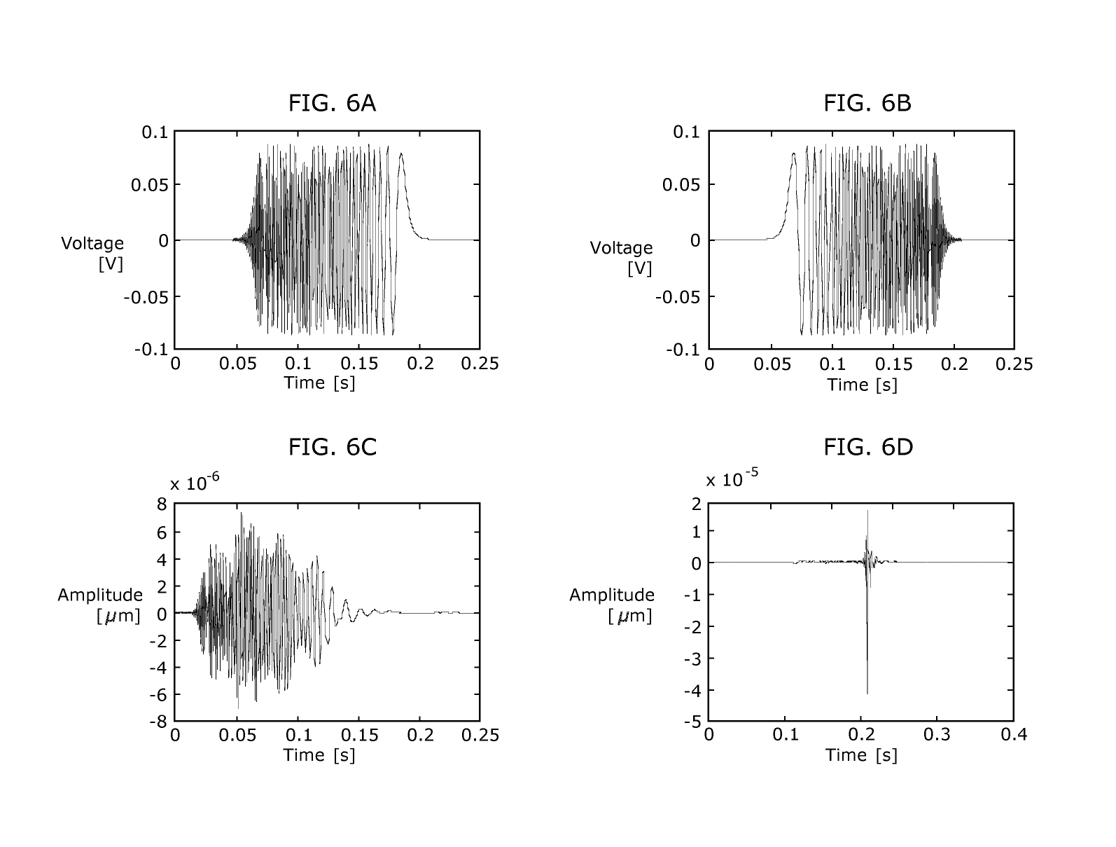

As Equation 6 shows, TSP is a signal whose time axis is stretched beyond the impulse by changing the phase of the impulse with the square of the frequency. FIG. 6A illustrates one example of TSP.

$$\begin{matrix}[ Math 6 ] & \\ \begin{matrix}H ( n ) = exp ( {jkn}^{2} ) & 0 \leq n \leq \frac{N}{2} \\ H ( n ) = {H}^{*} ( N - n ) & \frac{N}{2} + 1 \leq n \leq N\end{matrix} & ( Equation 6 )\end{matrix}$$

In Equation 1, H(n) represents TSP in the frequency domain, j represents an imaginary unit (square root of −1), k is a constant that represents a degree of expansion, n represents a discretized frequency unit, and H* represents a complex conjugate of H.

The actuator Aⱼ is driven using the signal obtained by calculating the reverse Fourier transform of the TSP from Equation 6, and the vibration (hereinafter referred to as TSP response) at the position Pᵢ(xᵢ, yᵢ) on the panel 101 is measured. The measuring method need not be limited to a particular method, but the vibration (TSP response) is measured using a Doppler displacement meter, for example. FIG. 6B illustrates one example of TSP response.

Impulse response is calculated using the measured TSP response. More specifically, the impulse response is calculated by a convolution operation using the inverse function of TSP, shown in Equation 7.

$$\begin{matrix}[ Math 7 ] & \\ \begin{matrix}{H}^{- 1} ( n ) = exp ( - {jkn}^{2} ) & 0 \leq n \leq \frac{N}{2} \\ {H}^{- 1} ( n ) = {H}^{*} ( N - n ) & \frac{N}{2} + 1 \leq n \leq N\end{matrix} & ( Equation 7 )\end{matrix}$$

In Equation 7, H⁻¹(n) represents the inverted function of TSP. FIG. 6C shows one example of the inverted function of TSP. FIG. 6D illustrates one example of the impulse response calculated from the TSP response in FIG. 6B.

As described above, the impulse response from the actuator Aⱼ to the position Pᵢ(xᵢ, yᵢ) is measured using TSP. By performing this measurement on all combinations of M actuators 102 (A₁, A₂, . . . , A_{M}) and N positions (P₁(x₁, y₁), P₂(x₂, y₂), . . . , P_{N}(x_{N}, y_{N})) for each piece of touch information, M×N transfer functions are obtained for each piece of touch information. The M×N transfer functions for each piece of touch information obtained in this manner are stored in the transfer function storage unit 106.

It should be noted that the method used to measure the transfer functions is not limited to the above-described method. For example, the transfer functions may be measured using an M-sequence signal. Moreover, the transfer functions may be measured using a Gaussian random variable, for example.

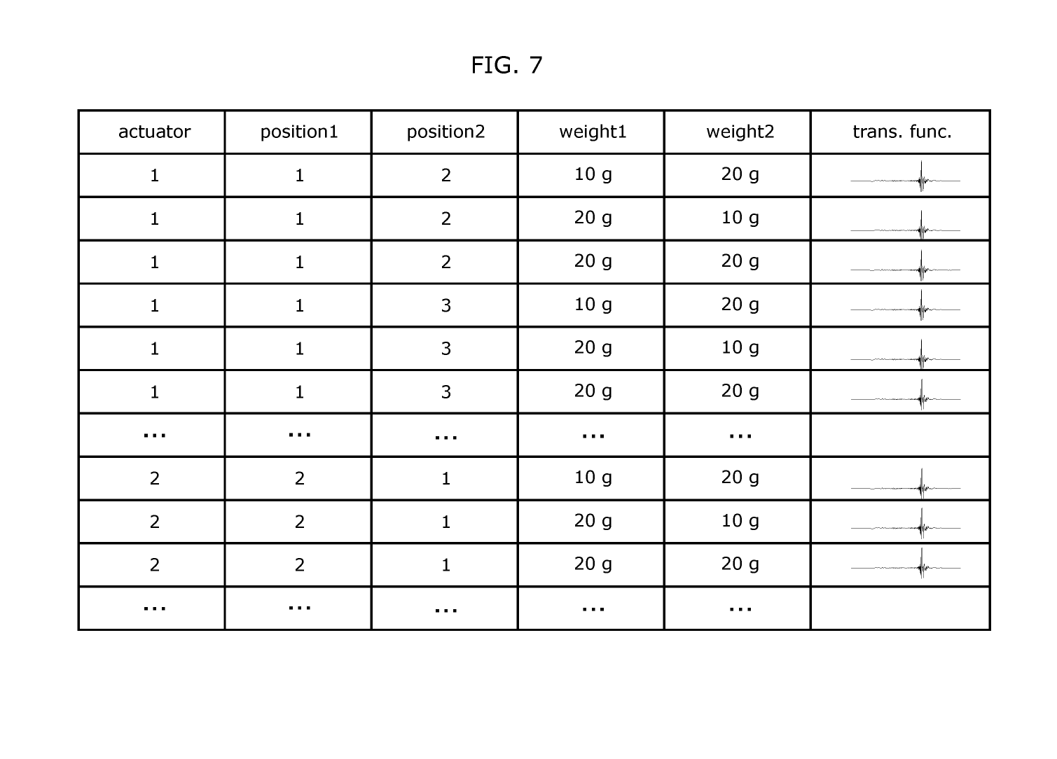

Next, transfer functions stored in the transfer function storage unit 106 when the touch information includes load information, there are two actuators (M=2), and there are two touch positions (N=2) will be described in detail with reference to FIG. 7.

FIG. 7 illustrates one example of the transfer functions that the transfer function storage unit 106 stores for each piece of touch information according to Embodiment 1. In this example, the transfer function storage unit 106 stores each transfer function (trans. func.) in association with a combination of one of the actuators 102 (actuator), two touch positions (position1, position 2), and loads at the two touch positions (weight1, weight2). Multiple denominations of loads are provided within the range of load values resulting from a normal touch. The number of load denominations is not limited to a particular number. The number of load denominations, for example, may be determined based on the storage capacity. For example, transfer functions for 11 denominations of loads—one for each 10 g increment from 0 g to 100 g—may be stored. Alternatively, transfer functions may be stored for each load value set such that the resolution capability (step size) of low load values decreases and the resolution capability (step size) of high load values increases. With this, the resolution capability of low load values generated by normal touches can be made minute and transfer functions corresponding to high load values generated by abnormal touches can be stored.

(Transfer Function Obtaining Unit 107)

From among a plurality of transfer functions stored in the transfer function storage unit 106, the transfer function obtaining unit 107 obtains transfer functions corresponding to touch positions obtained by the touch position obtaining unit 103 and touch information obtained by the touch information obtaining unit 105. In other words, the transfer function obtaining unit 107 retrieves, in accordance with the touch information, a transfer function from each actuator 102 to each touch position from the transfer function storage unit 106.

More specifically, the transfer function obtaining unit 107 obtains, based on two or more touch positions (P₁(x₁, y₁), P₂(x₂, y₂), . . . , Pᵢ(xᵢ, yᵢ), . . . , P_{N}(x_{N}, y_{N})) obtained by the touch position obtaining unit 103 and a load applied to each of the two or more touch positions (w₁, w₂, . . . , wₙ) and obtained by the touch information obtaining unit 105, a transfer function that is from each actuator (A₁, A₂, . . . , Aⱼ, . . . , A_{M}) to each touch position and corresponds to the touch information. For example, when there are N touch positions and M actuators, the transfer function obtaining unit 107 obtains N×M transfer functions gᵢⱼ. Transfer functions gᵢⱼ obtained in this way include N touch positions and touch information.

(Filter Calculating Unit 108) The filter calculating unit 108 calculates (generates) filters for filtering a given haptic signal to generated desired driving signals. Here, desired driving signals are signals which each drive one of the actuators 102 to vibrate the panel 101 at a feedback position according to the given haptic signal and not vibrate the panel 101 at a non-feedback position.

In other words, using the transfer functions obtained by the transfer function obtaining unit 107, the filter calculating unit 108 calculates filters for providing haptic feedback to only a feedback position from among the plurality of touch positions obtained by the touch position obtaining unit 103 and refraining from providing haptic feedback to other touch positions (non-feedback positions) among the plurality of touch positions obtained by the touch position obtaining unit 103. A more detailed explanation of the method of calculation used for this sort of filter will be given later.

(Haptic Signal Storage Unit 109)

The haptic signal storage unit 109 is, for example, a hard disk or semiconductor memory. The haptic signal storage unit 109 stores haptic signals. A haptic signal represents haptics provided to a user. In other words, the haptic signal indicates the vibrations on the panel 101 at the feedback position.

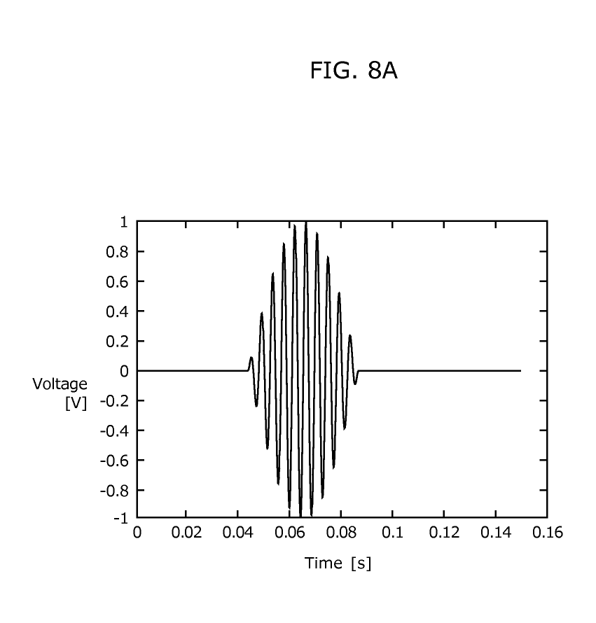

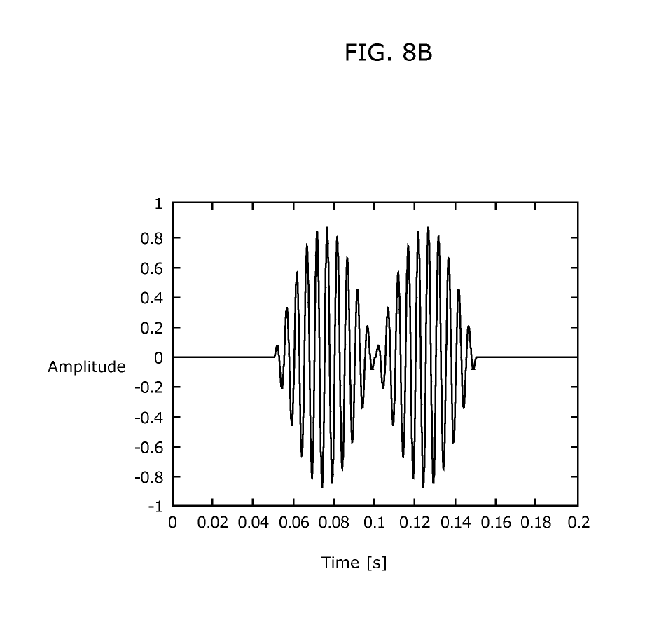

FIG. 8A and FIG. 8B are each examples of a haptic signal. In Embodiment 1, the haptic signal storage unit 109 stores haptic signals like those illustrated in FIG. 8A and FIG. 8B, for example.

The haptic signal may be any signal so long as it can provide the user with haptic feedback. For example, the haptic signal may be determined based on the vibration characteristics of the panel 101. More specifically, the haptic signal may be a signal with a frequency that matches or is in the vicinity of the resonance frequency of the panel 101, for example. As such, it is possible to effectively vibrate the panel 101 and thus improve energy efficiency.

Next, one example of the method for generating the haptic signal will be explained. When the haptic signal is generated based on a signal having an r cycle of a sine wave of a frequency fc, as Equation 8 shows, by modulating the sine wave using a modulating frequency fm which halves r cycle, a haptic signal s(n) such as the one illustrated in FIG. 8A is generated.

$$\begin{matrix}[ Math 8 ] & \\ s ( n ) = sin ( 2 π {f}_{m} {nT}_{s} ) sin ( 2 π {f}_{c} {nT}_{s} ) \\ {f}_{m} = \frac{{f}_{c}}{2 r} & ( Equation 8 )\end{matrix}$$

Here, Ts represents the sampling period. In the example illustrated in FIG. 8A, fc=200 Hz, r=10, and modulating frequency fm is 10 Hz. A haptic signal generated in this fashion can be used as a signal for providing haptic feedback when a GUI object button is clicked, for example.

It should be noted that the haptic signal is not necessarily required to be a signal generated in the above-described manner. For example, performing the modulation shown in Equation 8 is not required. In other words, a sine wave may be used as the haptic signal.

It should be noted that the frequency fc may be any frequency so long as it is a frequency that can be perceived as a haptic sensation by a human. For example, the frequency fc may be determined based on the vibration characteristics of the panel 101.

For example, the frequency fc may be determined to be equal to the resonance frequency of the panel 101. By determining the frequency fc in this manner, it is possible to reduce the attenuation of the vibration imparted to the panel 101 by the actuator 102 and efficiently provide haptic feedback.

It should be noted that in Embodiment 1, the haptic signals are generated in advance offline and stored in the haptic signal storage unit 109, but they may be generated online after detection of multiple touches. With this, it is possible to reduce the storage region for storing the haptic signals.

(Filtering Unit 110)

The filtering unit 110 generates driving signals for driving the actuators 102 by filtering a haptic signal stored in the haptic signal storage unit 109 using filters calculated by the filter calculating unit 108 for each actuator 102.

Each actuator 102 vibrates the panel 101 according to a driving signal generated by the filtering unit 110 in this manner. As a result, among the plurality of touch positions, vibrations based on the haptic signal occur only at the feedback position, and vibrations are kept to a minimum at non-feedback positions. With this, the haptic feedback device 100 is capable of providing haptic feedback to a user at the feedback position and refraining from providing haptic feedback at non-feedback positions.

[Haptic Feedback Device Operations]

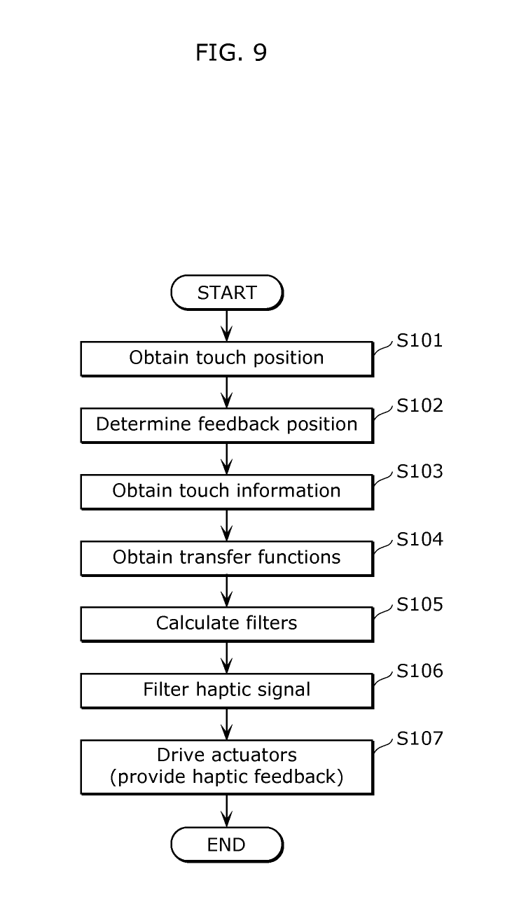

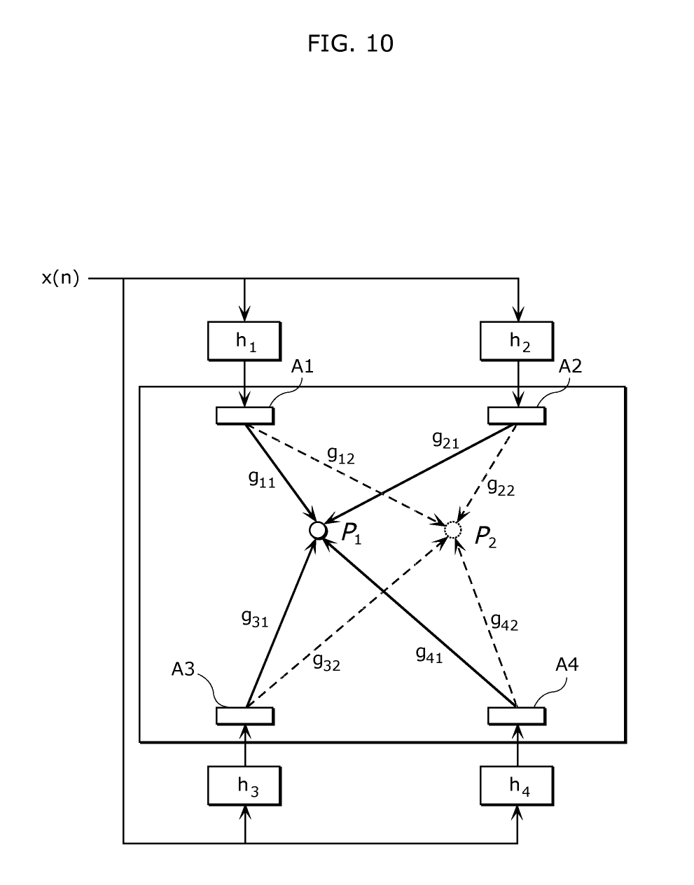

Next, operations performed by the haptic feedback device 100 having the above-described configuration will be described in detail. FIG. 9 is a flow chart of the processes performed by the haptic feedback device 100 according to Embodiment 1. FIG. 10 is for illustrating the processes performed by the haptic feedback device 100 according to Embodiment 1.

(Step S101)

First, the touch position obtaining unit 103 obtains a plurality of touch positions on the panel 101 by detecting multiple touches (S101). For example, the touch position obtaining unit 103 obtains the two touch positions P₁ and P₂ illustrated in FIG. 10.

More specifically, the touch position obtaining unit 103 obtains, for example, a center position of a finger of the user on the panel 101 in a predetermined time period as the touch position. It should be noted that the touch position obtaining unit 103 is not necessarily required to obtain the center position of a finger as the touch position. For example, the touch position obtaining unit 103 may obtain the position of the center of gravity of the load from a finger as the touch position.

(Step S102)

Next, from among the plurality of obtained touch positions, the haptic feedback determining unit 104 determines the first touch position (feedback position) at which to provide haptic feedback and a second touch position (non-feedback position) at which not to provide feedback (S102). For example, the haptic feedback determining unit 104 determines, from among the two touch positions P₁ and P₂, the feedback position to be the touch position P₁ and the non-feedback position to be the touch position P₂.

More specifically, the haptic feedback determining unit 104, for example, determines the feedback position based on information displayed. More specifically, the haptic feedback determining unit 104, for example, determines the feedback position to be a touch position at which a GUI object (a button or slider, for example) is displayed. Moreover, the haptic feedback determining unit 104 may, for example, determine the feedback position to be a touch position at which link information for a web browser is shown.

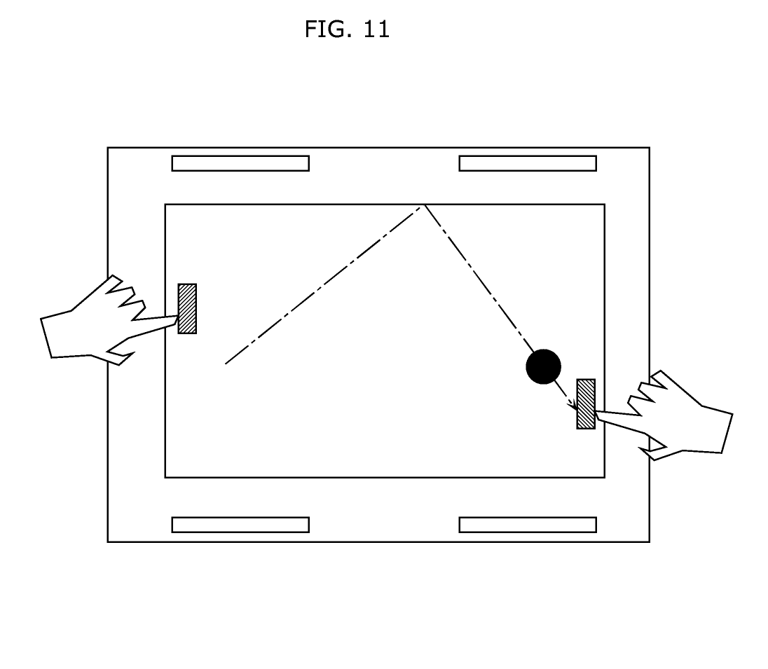

For example, when a multiplayer game is displayed, the haptic feedback determining unit 104 may determine a touch position that requires haptic feedback based on the state of the game to be the feedback position. More specifically, when an air hockey game is displayed on the screen, as illustrated in FIG. 11, when the puck and the paddle touch, haptic feedback is desirably provided at the position where the paddle is displayed. As such, the haptic feedback determining unit 104 determines the display position (touch position) of the paddle in contact with the puck to be the feedback position, and determines the display position (touch position) of the other paddle to be a non-feedback position.

It should be noted that the haptic feedback determining unit 104 is not necessarily required to determine the feedback position based on information displayed. For example, the haptic feedback determining unit 104 may determine the feedback position based on the magnitude of a load, duration of a touch, or positional relationship between a plurality of touch positions.

Moreover, the haptic feedback determining unit 104 is not required to always determine the feedback position when a plurality of touch positions are obtained by the touch position obtaining unit 103. For example, when no touch position among the plurality of touch positions fulfills a predetermined condition, the haptic feedback determining unit 104 may determine all touch positions to be non-feedback positions without determining a feedback position. Moreover, for example, when temporal changes in a touch position are great, all touch positions may be determined to be non-feedback positions. In this case, since provision of haptic feedback is not required, processing returns to step S101.

(Step S103)

Next, the touch information obtaining unit 105 obtains touch information including at least one of information indicating a state of the panel 101 at the point in time when a plurality of touches are detected or information indicating a characteristic of the input object at the point in time when a plurality of touches are detected (S103). More specifically, the touch information obtaining unit 105 obtains at least one of load at the touch position, contact surface area at the touch position, or hardness of the input object. The method of obtaining the touch information is not limited to one specific example, but the load applied to each touch position may be obtained as the touch information using load sensors 121 provided at the four corners of the back surface of the panel 101, as is illustrated in FIG. 3.

(Step S104)

Next, the transfer function obtaining unit 107 obtains, from the transfer function storage unit 106, transfer functions corresponding to the plurality of touch positions obtained by the touch position obtaining unit 103 and the touch information obtained by the touch information obtaining unit 105 (S104). For example, the haptic feedback determining unit 104 retrieves, from the transfer function storage unit 106, transfer functions g₁₁, g₁₂, g₁₃, and g₁₄, which correspond to a combination of two loads applied to the touch position P₁ and the touch position P₂ and are from the actuators A₁, A₂, A₃, and A₄, to the touch position P₁, and transfer functions g₂₁, g₂₂, g₂₃, and g₂₄, which correspond to a combination of two loads applied to the touch position P₁ and the touch position P₂ and are from the actuators A₁, A₂, A₃, and A₄, to the touch position P₂.

(Step S105)

Next, the filter calculating unit 108 calculates filters for providing haptic feedback at feedback positions and refraining from providing haptic feedback at non-feedback positions (S105). More specifically, the filter calculating unit 108 calculates filters using the transfer functions from the actuators 102 to the feedback positions and the transfer functions from the actuators 102 to the non-feedback positions. For example, the haptic feedback determining unit 104 calculates filters for providing haptic feedback at the touch position P₁ and for refraining from providing haptic feedback at the touch position P₂ using the transfer functions g₁₁, g₁₂, g₁₃, g₁₄, g₂₁, g₂₂, g₂₃, and g₂₄.

Next, a more detailed example of a method of calculating the filters will be given.

Here, the transfer function (impulse response) gᵢⱼ from the actuator Aⱼ to the touch position Pᵢ is expressed as Equation 9 shows. Moreover, the filter hⱼ for generating the driving signal for the actuator Aⱼ is expressed as Equation 10 shows. Furthermore, the response (output) dᵢ at the touch position Pᵢ relative to the input to all actuators A₁ through A_{M} is represented as Equation 11 shows.

[Math 9]

gᵢⱼ=[gᵢⱼ(0)gᵢⱼ(1) . . . gᵢⱼ(L_{g})]^{T} (Equation 9)

[Math 10]

hⱼ=[hⱼ(0)hⱼ(1) . . . hⱼ(L)]^{T} (Equation 10)

[Math 11]

dᵢ=[dᵢ(0)dᵢ(1) . . . dᵢ(L_{g}+L)]^{T} (Equation 11)

In Equation 9, L_{g} represents the length of the impulse response. In Equation 10, L represents the length of the filter (filter length). The longer the filter length, the more detailed the control can become.

Next, the relationship between (i) the input to the actuators A₁ through A_{M}, and the filters h₁ through h_{M} and (ii) the response dᵢ at one touch position Pᵢ will be considered. The response at one touch position Pᵢ relative to the input to one actuator Aⱼ is calculated using the convolution of the filter hⱼ and the transfer function gᵢⱼ. It is possible to calculate the response dᵢ at one touch position Pᵢ relative to the input to all of the actuators A₁ through A_{M} by overlapping the responses at one touch position Pi relative to the input to one actuator Aⱼ for all of the actuators A₁ through A_{M}. In other words, the response dᵢ can be expressed as Equation 12 shows using a filter hⱼ and a transfer function gᵢⱼ.

$$\begin{matrix} [ Math 12 ] & \\ [ \begin{matrix}{d}_{1} ( 0 ) \\ {d}_{1} ( 1 ) \\ ⋮ \\ ⋮ \\ {d}_{N} ( 0 ) \\ {d}_{N} ( 1 ) \\ ⋮\end{matrix} ] = [ \begin{matrix}{g}_{11} ( 0 ) & … & 0 & … & {g}_{M 1} ( 0 ) & … & 0 \\ {g}_{11} ( 1 ) & … & 0 & … & {g}_{M 1} ( 1 ) & … & 0 \\ ⋮ & ⋱ & ⋮ & … & ⋮ & ⋱ & ⋮ \\ 0 & … & {g}_{11} ( {L}_{g} ) & … & 0 & … & {g}_{M 1} ( {L}_{g} ) \\ & ⋮ & & & & ⋮ & \\ {g}_{N} ( 0 ) & … & 0 & … & {g}_{MN} ( 0 ) & … & 0 \\ {g}_{1 N} ( 1 ) & … & 0 & … & {g}_{MN} ( 1 ) & … & 0 \\ ⋮ & ⋱ & ⋮ & … & ⋮ & ⋱ & ⋮ \\ 0 & … & {g}_{1 N} ( {L}_{g} ) & … & 0 & … & {g}_{MN} ( {L}_{g} )\end{matrix} ] [ \begin{matrix}{h}_{1} ( 0 ) \\ {h}_{1} ( 1 ) \\ ⋮ \\ ⋮ \\ {h}_{N} ( 0 ) \\ {h}_{N} ( 1 ) \\ ⋮\end{matrix} ] & ( Equation 12 )\end{matrix}$$

As Equation 12 shows, the responses d₁ through d_{N} at the touch positions P₁ through P_{N} relative to the inputs to the actuators A₁ through A_{M} are expressed as the sum of convolutions of the transfer function gᵢⱼ from each actuator Aⱼ to each touch position Pᵢ and the filter hⱼ to be calculated.

Here, a desired filter can be obtained if the filter hj can be calculated so that only the response dₖ at the touch position Pₖ (0<k≦N) among the plurality of touch positions P₁ through P_{N} is an impulse (dₖ(0)=1, dₖ(1)=0, dₖ(2)=0, . . . , dₖ(M)=0), and the responses at all other touch positions Pₗ (0<l≦N, l≠k) is zero (dₗ(0)=0, dₗ(1)=0, dₗ(2)=0, . . . , dₗ(M)=0). In other words, by filtering a given haptic signal using the filter hⱼ calculated in this manner, it is possible to generate driving signals for providing haptic feedback according to the given haptic signal only at the touch position Pₖ and refrain from providing haptic feedback at other touch positions Pₗ (l≠k).

The filter calculating unit 108 calculates the filters so that a sum of convolution results, in the time domain, of the transfer functions from the plurality of actuators 102 to the feedback position and the filters indicates an impulse and a sum of convolution results, in the time domain, of the transfer functions from the plurality of actuators 102 to the non-feedback position and the filters indicates zero.

The method of calculating the above-described filters is not particularly limited to a given method, but the filters can be calculated by calculating the generalized inverse matrix G* of G, as Equation 13 shows. In other words, it is possible to calculate FI, which represents a desired filter, from D, which indicates impulse, and the generalized inverse matrix G* of G.

[Math 13]

H=G*D (Equation 13)

Typically, it is possible to solve Equation 13 if the number of actuators (M) is greater than or equal to the number of touch positions (N). It should be noted that in order to stably solve Equation 13 with respect to an arbitrary combination of touch positions, at each position, it is desirable that the transfer functions gᵢⱼ from the plurality of actuators 102 do not have the same zero point. For example, when there are two touch positions, by providing two actuators 102 at the edge on each lengthwise side of the panel 101, as is illustrated in FIG. 3, it is possible to arrange the actuators 102 so that the transfer functions at two given points are different.

It should be noted that zero point refers to a frequency, in the frequency domain, at which the transfer function level is 0 or as close to 0 as possible. In other words, when a zero point is included in the transfer function, even if a zero point frequency component is included in the input, that frequency component is, for the most part, not included in the output.

As such, when transfer functions from all actuators 102 to a given position have a zero point at the same frequency, regardless of the kind of signal inputted, the panel 101 will not vibrate at that position, at that frequency. In other words, capability of controlling vibration at a specific frequency is lost. Consequently, at each frequency to be used for control, it is desirable that the transfer functions from at least one actuator 102 have a characteristic that is not a zero point.

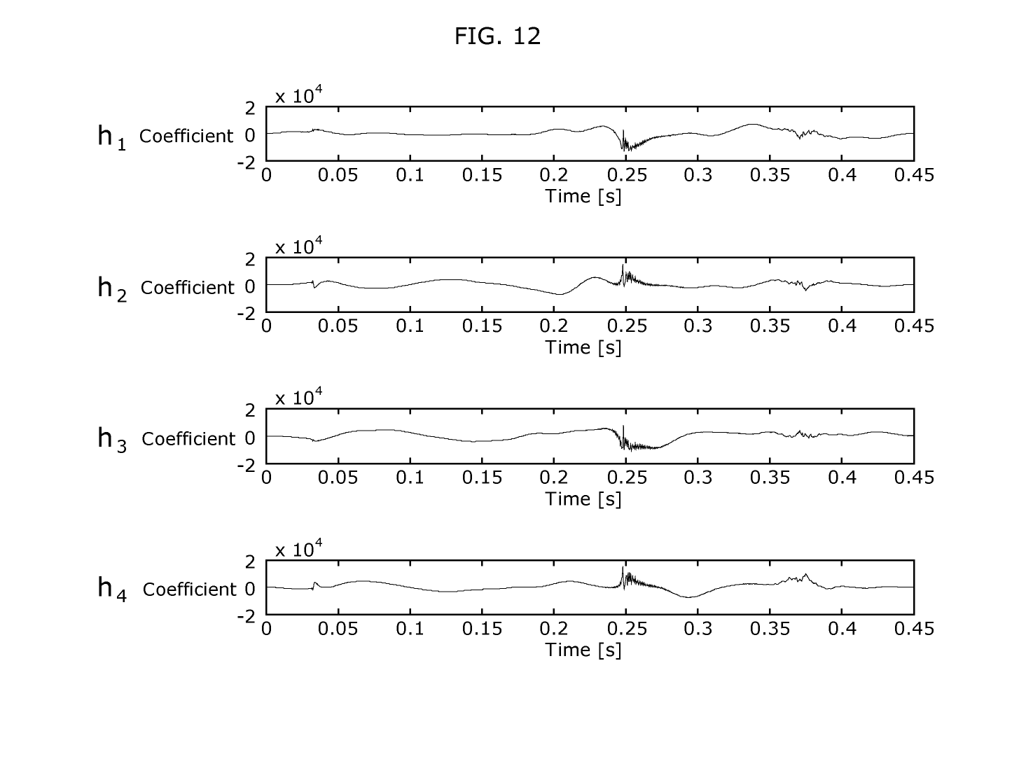

FIG. 12 illustrates examples of filters. More specifically, FIG. 12 illustrates the filters calculated when the touch position P₁ in FIG. 10 is determined to be the feedback position.

(Step S106)

Next, the filtering unit 110 filters a haptic signal stored in the haptic signal storage unit 109 using the filters calculated in step S105 to generate driving signals for driving the actuators 102 (S106). More specifically, the filtering unit 110 calculates a convolution of the haptic signal s(n) and the filter hⱼ(n) to generate the driving signal for the actuator Aⱼ.

It should be noted that when a plurality of haptic signals are stored in the haptic signal storage unit 109, the filtering unit 110 selects one haptic signal from among the plurality of haptic signals, and filters the selected haptic signal. For example, the filtering unit 110 selects the haptic signal illustrated in FIG. 8A from among the haptic signals illustrated in FIG. 8A and FIG. 8B. It should be noted that the selection method of the haptic signal does not need to be restricted to this example.

Next, the filtering process will be discussed in more detail. The filtering unit 110 generates a driving signal uⱼ(n) for driving the actuator Aⱼ, as Equation 14 shows. In other words, the filtering unit 110 generates the driving signal uⱼ(n) by calculating a convolution of the haptic signal s(n) and the filter hⱼ(n) calculated by the filter calculating unit 108.

[Math 14]

uⱼ(n)=s(n) [symbol] hⱼ(n)=Σs(n−k)hⱼ(k) (Equation 14)

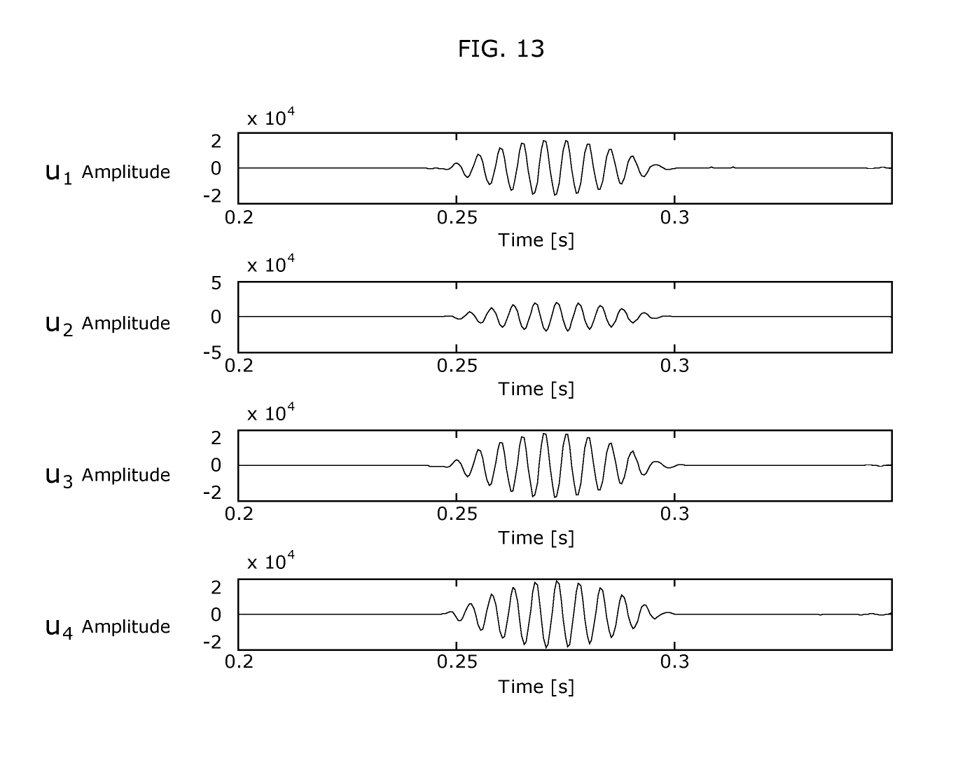

FIG. 13 illustrates examples of the driving signals. In other words, FIG. 13 illustrates examples of the driving signals generated by the filtering unit 110 according to Equation 14. More specifically, FIG. 13 illustrates driving signals generated by processing the haptic signal illustrated in FIG. 8A using the filters illustrated in FIG. 12.

Next, differences between vibrations at the touch position P₂, which is a non-feedback position, when touch information is and is not taken into account will be described.

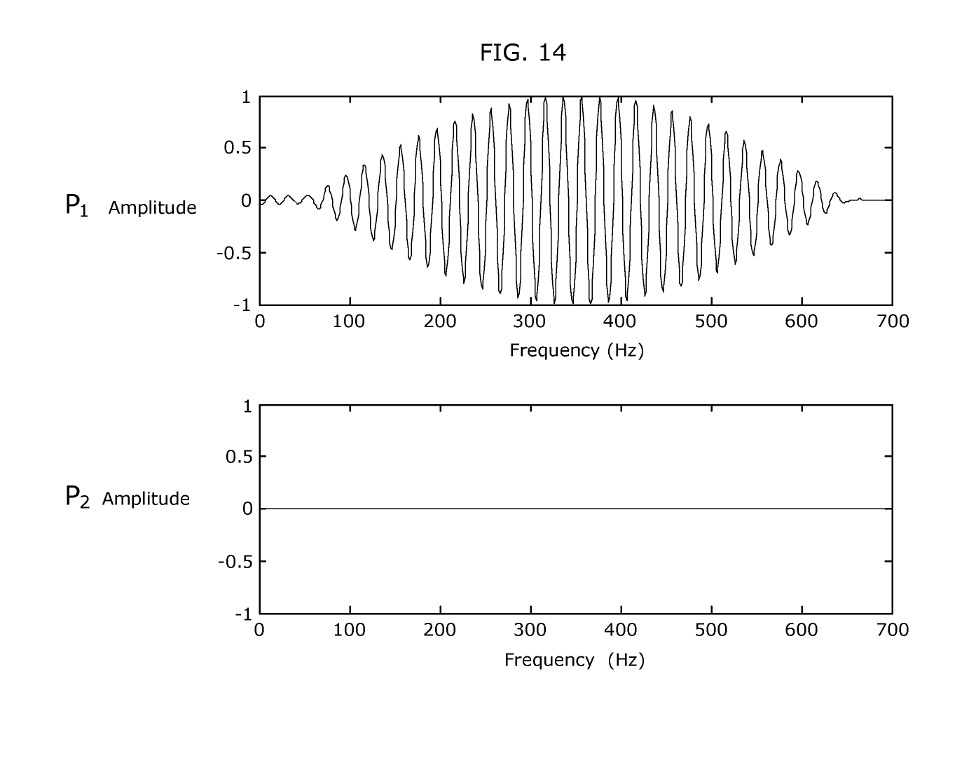

First, the case where touch information is taken into account will be described. FIG. 14 illustrates actual results of vibration characteristics at touch positions according to Embodiment 1. More specifically, FIG. 14 illustrates actual results of vibration characteristics at touch positions when the driving signals are generated taking into account the touch information. Even more specifically, FIG. 14 illustrates the vibration characteristics at touch position P₁ and touch position P₂ when the actuators 102 are driven using the driving signals illustrated in FIG. 13 in the state illustrated in FIG. 10. In FIG. 14, when the amplitude level of touch position P₁ is 1, the amplitude level of touch position P₂ is approximately zero. In other words, haptic feedback is provided at only touch position P₁ among the two touch positions.

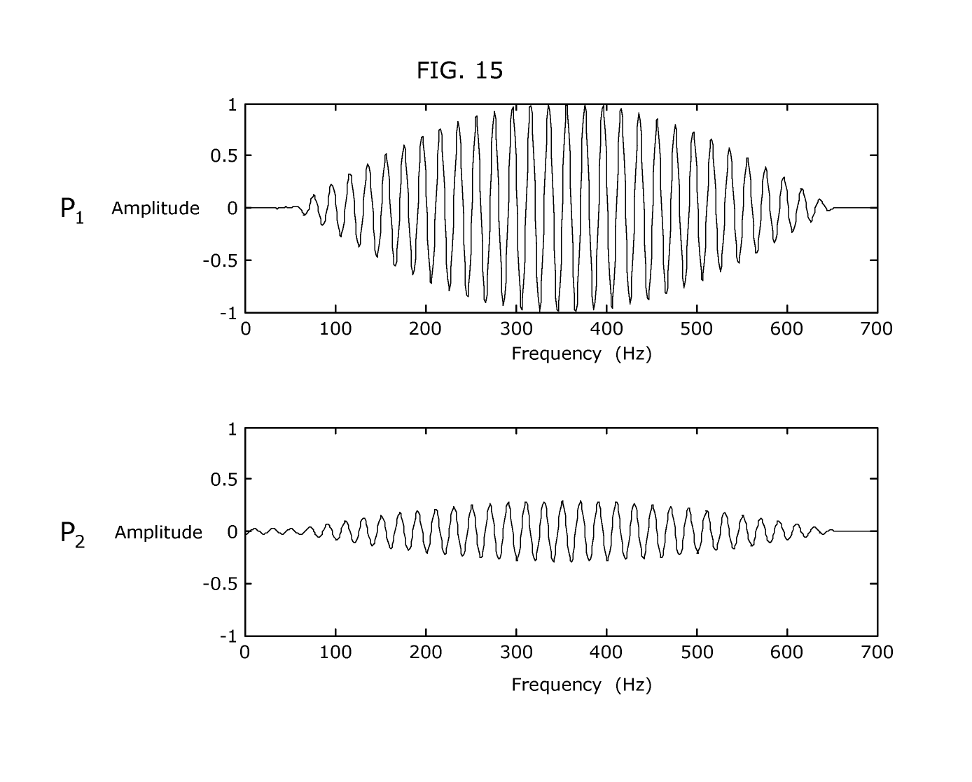

Next, the case where touch information is not taken into consideration will be described. FIG. 15 illustrates actual results of vibration characteristics at touch positions according to a comparative example. More specifically, FIG. 15 illustrates actual results of vibration characteristics at touch positions when the driving signals are generated not taking into account the touch information. Even more specifically, FIG. 15 illustrates the vibration characteristics at touch position P₁ and touch position P₂ when the actuators 102 are driven using driving signals using transfer functions when zero load is applied to the panel 101. In FIG. 15, when the amplitude level of touch position P₁ is 1, the amplitude level of touch position P₂ is approximately 0.3. In other words, haptic feedback is provided at touch position P₂ in addition to touch position P₁. As this shows, when variation in the transfer functions of panel 101 accompanied by touches is not taken into account, haptic feedback is provided, to some degree, at positions where haptic feedback is not intended to be provided. Consequently, feedback unintended by the designer to be provided to the user is provided to the user.

(Step S107)

Next, the actuator Aⱼ is driven using the driving signal uⱼ(n) generated in step S106 (S107). In other words, the actuator Aⱼ vibrates the panel 101 according to the driving signal uⱼ(n). As a result, haptic feedback is provided at only touch position P₁ among the two touch positions, as FIG. 14 illustrates.

It should be noted that depending on the type of actuators 102 used, high voltage driving signals may be required. In this case, the actuators 102 may include an amplifier for amplifying the driving signals.

It should be noted that vibration characteristics at the touch positions P₁ and P₂ are illustrated in FIG. 14, but locations other than the touch positions P₁ and P₂ are also vibrating. However, since the user is not touching any location other than the touch positions P₁ and P₂, haptic feedback is not provided to the user regardless of what kind of vibration is occurring.

### Advantageous Effect

As described above, with the haptic feedback device 100 according to Embodiment 1, it is possible to control driving of the actuators 102 using driving signals generated using panel 101 transfer functions which correspond to touch information. Consequently, the haptic feedback device 100 is capable of adjusting for variations in the transfer functions of the panel caused by touches and vibrating the panel 101 accordingly. This allows the haptic feedback device 100 to provide suitable haptic feedback to the user for multiple touches. For example, the haptic feedback device 100 can provide suitable haptic feedback by providing only a touch requiring haptic feedback among multiple touches with haptic feedback. In other words, the haptic feedback device 100 is capable of minimizing unnecessary confusion caused by haptic feedback.

Moreover, the driving signals for driving the actuators 102 are signals generated using transfer functions. As such, even if the feedback position and the actuator are not located close to each other, it is possible to impart vibration at the feedback position and not impart vibration at the non-feedback position. In other words, since it is not necessary to provide a multitude of actuators below the panel, it is possible to efficiently provide haptic feedback for multiple touches. Furthermore, even in cases where a display apparatus is provided below the panel, provision of transparent actuators is not required, making it possible to relatively simply manufacture the haptic feedback device.

Moreover, with the haptic feedback device 100 according to Embodiment 1, it is possible to control the actuators 102 using touch information including at least one of load information, contact surface area information, or hardness information. In other words, the haptic feedback device 100 can provide even more suitable haptic feedback by controlling the actuators 102 using information which alters the transfer functions of the panel 101.

It should be noted that in Embodiment 1, the haptic feedback device 100 is provided with the transfer function storage unit 106 and the haptic signal storage unit 109, but provision of these storage units is not absolutely necessary. In the case that these storage units are not provided, the haptic feedback device 100, for example, may obtain a transfer function or a haptic signal from a storage device connected over a network.

### Variation 1 of Embodiment 1

The haptic feedback device according to Variation 1 of Embodiment 1 is different from Embodiment 1 in that the filters are calculated in the frequency domain instead of the time domain. Hereinafter, Variation 1 of Embodiment 1 will be described focusing on the points that differ from Embodiment 1.

The filter calculating unit 108 calculates the filters so that a sum of products, in the frequency domain, of the transfer functions from the plurality of actuators 102 to the feedback position and the filters indicates an impulse and a sum of products, in the frequency domain, of the transfer functions from the plurality of actuators 102 to the non-feedback position and the filters indicates zero.

More specifically, the filter calculating unit 108 calculates the filters in the frequency domain in the following manner.

The response D expressed in the frequency domain is expressed using the transfer function G expressed in the frequency domain and the filter H, as Equation 15 shows,

$$\begin{matrix}[ Math 15 ] & \\ D = GH \\ D = [ \begin{matrix}{D}_{1} ( ω ) \\ {D}_{2} ( ω ) \\ ⋮ \\ {D}_{N} ( ω )\end{matrix} ] \\ G = [ \begin{matrix}{G}_{11} ( ω ) & {G}_{12} ( ω ) & … & {G}_{1 M} ( ω ) \\ {G}_{21} ( ω ) & {G}_{22} ( ω ) & … & {G}_{2 M} ( ω ) \\ ⋮ & ⋮ & ⋱ & ⋮ \\ {G}_{N 1} ( ω ) & {G}_{N 2} ( ω ) & … & {G}_{NM} ( ω )\end{matrix} ] \\ H = [ \begin{matrix}{H}_{1} ( ω ) \\ {H}_{2} ( ω ) \\ ⋮ \\ {H}_{M} ( ω )\end{matrix} ] & ( Equation 15 )\end{matrix}$$

In Equation 15, the transfer functions Gᵢⱼ(ω) are transfer functions from the actuators Aⱼ to the touch positions Pᵢ, and are expressed in the frequency domain. Moreover, the filters Nⱼ(ω) are filters for generating the driving signals for the actuators Aⱼ, and are expressed in the frequency domain. Moreover, the responses Dᵢ(ω) are responses at the touch positions Pᵢ, and are represented in the frequency domain.

Here, in the frequency band targeted for control, a desired filter can be obtained if the filter H can be calculated so that only the response dₖ at the touch position Pₖ (0<k≦N) among the plurality of touch positions P₁ through P_{N} is an impulse (Dₖ(ω)=1), and the responses at all other touch positions Pₗ (0<l≦N, l≠k) is zero (Dₗ(ω)=0).

It should be noted that the frequency band targeted for control may be determined, for example, based on the frequency band detectable as haptic sensation by humans. In general, since humans can acutely detect haptic sensation from a few Hz to 500 Hz, the frequency band targeted for control may be set to from 10 Hz to 500 Hz.

The method of calculating the above-described filters is not particularly limited to a given method, but the filters can be calculated by calculating the generalized inverse matrix G* of G, as Equation 16 shows. In other words, it is possible to calculate H, which represents a desired filter, from D, which indicates impulse, and the generalized inverse matrix G* of G.

[Math 16]

H=G*D (Equation 16)

In this way, the filter calculating unit 108 can easily calculate the filter if the generalized inverse matrix G* shown in Equation 16 is calculated. In Variation 1 of Embodiment 1, G represented in the frequency domain is a matrix of N rows and M columns, as Equation 15 shows. As such, it is possible to calculate the generalized inverse matrix G* more easily than G represented in the time domain shown in Equation 7 in Embodiment 1.

In other words, with the haptic feedback device according to Variation 1 of Embodiment 1, it is possible to relatively easily calculate the reverse matrix of a matrix of the transfer functions by calculating filters in the frequency domain, making it is possible to reduce processing load. With this it is possible to suitably provide haptic feedback for multiple touches even in devices with low processing capability such as smart phones or tablet computers. Moreover, since the processing load for haptic feedback can be reduced, processes for haptic feedback can be performed in parallel with other processes.

### Variation 2 of Embodiment 1

The haptic feedback device according to Variation 2 of Embodiment 1 is different from Embodiment 1 in that the transfer function storage unit 106 stores each transfer function in association with a combination of one of the plurality of actuators 102, a plurality of touch positions, and a load at, among a plurality of touch positions, a touch position other than a touch position at which haptic feedback according to a haptic signal is provided.

More specifically, in Embodiment 1, the transfer function storage unit 106 stores each transfer function in association with a combination of one of the plurality of actuators 102, a plurality of touch positions, and loads at the plurality of touch positions. However, when each transfer function is stored in association with a combination of one of the plurality of actuators 102, a plurality of touch positions, and loads at the plurality of touch positions, the transfer function storage unit 106 is required to store a vast number of transfer functions. In other words, if there are C number grid points on the panel, N number of touch positions of concurrent touches, and the load value pattern is K, in Embodiment 1, the transfer function storage unit 106 is required to store _{C}C_{N}×K number of transfer functions.

As such, in Variation 2 of Embodiment 1, the transfer function storage unit 106 stores each transfer function in association with a combination of one of the plurality of actuators, a plurality of touch positions, and a load at, among a plurality of touch positions, only a touch position at which haptic feedback is not to be provided. This makes it possible to reduce the storage space for storing the transfer functions in the transfer function storage unit 106. In other words, in Variation 2 of Embodiment 1, the transfer function storage unit 106 is only required to store _{C}C_{N-1}×K number of transfer functions, which is less than the _{C}C_{N}×K number of transfer functions.

Hereinafter, Variation 2 of Embodiment 1 will be described focusing on the points that differ from Embodiment 1.

(Transfer Function Storage Unit 106)

The transfer function storage unit 106 stores transfer functions from each actuator 102 to each point on the panel 101, for each piece of touch information.

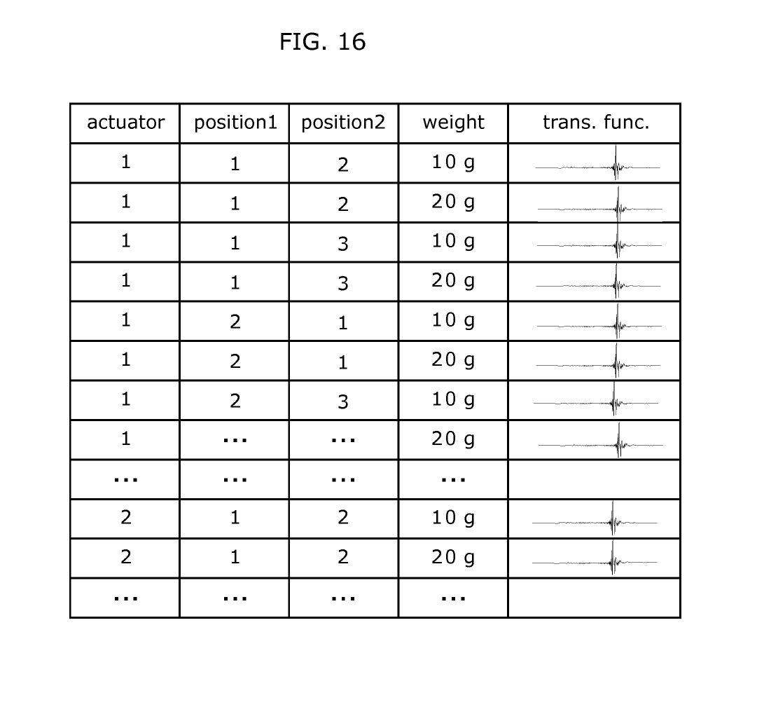

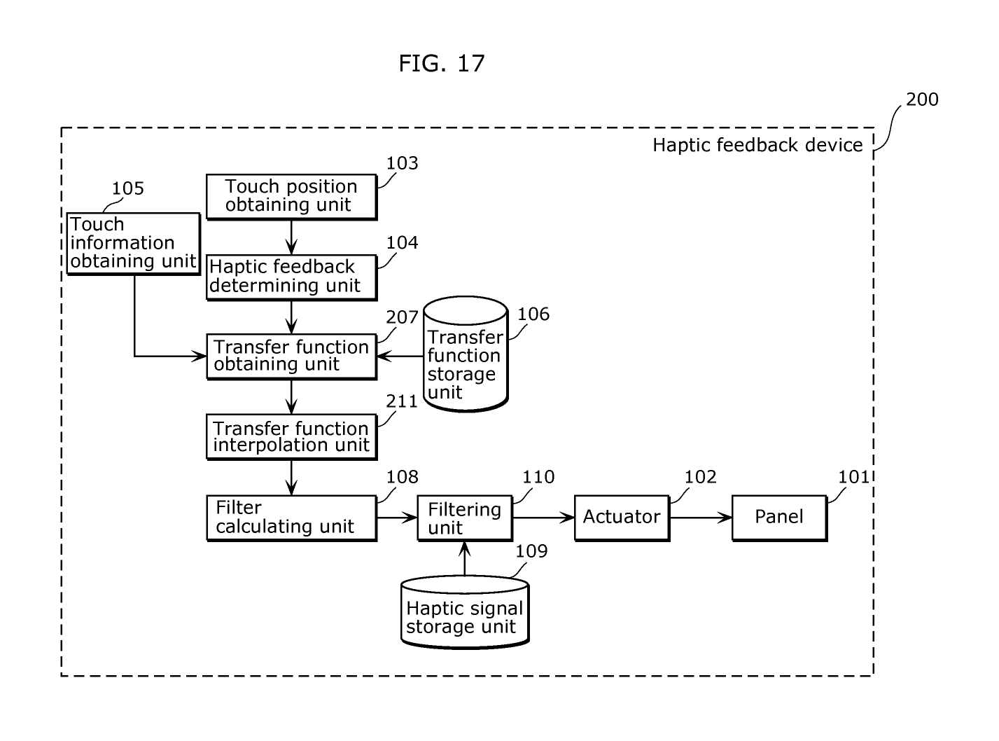

FIG. 16 illustrates one example of the transfer functions that the transfer function storage unit 106 stores for each piece of touch information according to Variation 2 of Embodiment 1, in this example, the transfer function storage unit 106 stores each transfer function (trans, func.) in association with a combination of one of the actuators 102 (actuator), two touch positions (position1, position2), and a load at one of the two touch positions (weight).

For example, in the first row in FIG. 16, when the load is 10 g at touch position 2 (the second touch position), the transfer function from actuator 1 to touch position 1 (the first touch position) is stored. Similarly, in the second row, when the load is 20 g at touch position 2, the transfer function from actuator 1 to touch position 1 is stored. In this way, in Variation 2 of Embodiment 1, the transfer function storage unit 106 stores transfer functions associated only with a load at, among touch position 1 (feedback position) and touch position 2 (non-feedback position), touch position 2.

In this way, by storing transfer functions in association with combinations for loads at a touch position at which haptic feedback is not to be provided rather than combinations for loads at all of the plurality of touch positions, it is possible to greatly reduce the storage space required to store transfer functions compared to Embodiment 1.

(Transfer Function Obtaining Unit 107)

The transfer function obtaining unit 107 obtains, based on two or more touch positions (P₁(x₁, y₁), P₂(x₂, Y₂), . . . , Pᵢ(xᵢ, Yᵢ), . . . , P_{N}(x_{N}, y_{N})) obtained by the touch position obtaining unit 103 and a load applied to a non-feedback position among loads applied to the two or more touch positions (w₁, w₂, . . . , w_{N}) and obtained by the touch information obtaining unit 105, a transfer function from each actuator (A₁, A₂, . . . , Aⱼ, . . . , A_{N}) to each touch position.

(Filter Calculating Unit 108)

The filter calculating unit 108 calculates filters using the transfer functions obtained by the transfer function obtaining unit 107. In other words, the filters calculated by the filter calculating unit 108 are calculated using transfer functions of the panel 101 which (i) are from the actuators to the feedback position and the non-feedback position and (ii) correspond to information associated with the non-feedback position among the touch information.

In this way, by calculating filters using transfer functions corresponding to the load applied to non-feedback positions rather than feedback positions, the filter calculating unit 108 can accurately control vibration at a touch position at which haptic feedback according to a haptic signal is not to be provided (non-feedback position).

It should be noted that in the above explanation, load information was used as the touch information, but the touch information is not limited to this example. The touch information may include contact surface area information or hardness information on the input object.

As described above, with the haptic feedback device 100 according to Variation 2 of Embodiment 1, it is possible to calculate filters using transfer functions corresponding to information associated with a non-feedback position among the touch information. Consequently, the haptic feedback device 100 can control vibration of the panel 101 at a non-feedback position more so than when transfer functions corresponding to information associated with a feedback position are used, making it possible to provide even more suitable haptic feedback.

Moreover, the transfer function storage unit 106 may store transfer functions in association with information associated with a non-feedback position among the touch information. Consequently, the number of transfer functions to be stored in the transfer function storage unit 106 can be greatly reduced compared to when transfer functions associated with combinations of a feedback position and a non-feedback position are stored. In other words, the haptic feedback device 100 is capable of reducing the storage space required to store the transfer functions. As such, the haptic feedback device 100 can even be used in devices with memory having a low storage capacity such as smart phones or tablet computers.

### Embodiment 2

In Embodiment 2, the haptic feedback device interpolates a transfer function corresponding to the touch information using a plurality of transfer functions stored in the transfer function storage unit. With this, even when obtained touch information is different from touch information stored in the transfer function storage unit, the haptic feedback device can generate filters using transfer functions suitable for the touch information, making it possible to suitably provide haptic feedback. Furthermore, the haptic feedback device can reduce the number of transfer functions stored in the transfer function storage unit.

[Haptic Feedback Device Configuration]

FIG. 17 illustrates the functional configuration of a haptic feedback device 200 according to Embodiment 2. In FIG. 17, the structural components that are the same as those in FIG. 2 share the same reference numerals, and as such, explanations thereof are omitted.

The haptic feedback device 200 includes the panel 101, a plurality of the actuators 102, the touch position obtaining unit 103, the haptic feedback determining unit 104, the touch information obtaining unit 105, the transfer function storage unit 106, a transfer function obtaining unit (processor) 207, a transfer function interpolation unit (processor) 211, the filter calculating unit 108, the haptic signal storage unit 109, and the filtering unit 110.

(Transfer Function Obtaining Unit 207)

The transfer function obtaining unit 207 obtains, from the transfer function storage unit 106, a plurality of transfer functions corresponding to a plurality of pieces of touch information similar to the touch information obtained by the touch information obtaining unit 105. More specifically, the transfer function obtaining unit 207 obtains, based on two or more touch positions (P₁(x₁, y₁), P₂(x₂, y₂), . . . , Pᵢ(xᵢ, Yᵢ), . . . , P_{N}(x_{N}, Y_{N})) obtained by the touch position obtaining unit 103 and loads applied to the two or more touch positions (w₁, w₂, . . . , w_{N}) and obtained by the touch information obtaining unit 105, a transfer function from each actuator (A₁, A₂, . . . , Aⱼ, . . . , A_{M}) to each touch position. Here, when a transfer function corresponding to the load value obtained by the touch information obtaining unit 105 is not stored, the transfer function obtaining unit 207 obtains a plurality of transfer functions corresponding to load values similar to the obtained load value.

For example, the transfer function obtaining unit 207 obtains transfer functions corresponding to load values having a degree of similarity with the obtained load value that is within a predetermined threshold. Moreover, for example, the transfer function obtaining unit 207 may obtain a predetermined number of transfer functions in descending order of degree of similarity with the obtained load value.

For example, in the case that K transfer functions having a high degree of similarity with the obtained load value are obtained, when there are N touch positions and M actuators, the transfer function obtaining unit 207 obtains N×M×K transfer functions gᵢⱼ^{k}.

Transfer functions gᵢⱼ obtained in this way correspond to N touch positions and touch information (load values). As such, the transfer function obtaining unit 207 can obtain transfer functions taking into account the effect a touch has on the panel 101.

(Transfer Function Interpolation Unit 211)

The transfer function interpolation unit 211 interpolates a transfer function corresponding to the obtained touch information using a plurality of transfer functions corresponding to a plurality of pieces of touch information similar to the obtained touch information. More specifically, using the plurality of transfer functions gᵢⱼ^{k} obtained by the transfer function obtaining unit 207, the transfer function interpolation unit 211 interpolates a transfer function gᵢⱼ, which is from actuator j to touch position i and corresponds to touch information obtained by touch information obtaining unit 105.

For example, the transfer function interpolation unit 211 interpolates a transfer function corresponding to the obtained touch information in the time domain. Moreover, for example, the transfer function interpolation unit 211 may interpolate a transfer function corresponding to the obtained touch information in the frequency domain.

For example, when a transfer function is interpolated in the time domain, the transfer function interpolation unit 211 may interpolate a transfer function corresponding to the obtained touch information using a linear combination of the plurality of obtained transfer functions. More specifically, the transfer function interpolation unit 211 can interpolate a transfer function using Equation 17.

$$\begin{matrix}[ Math 17 ] & \\ {g}_{ij} ( t ) = {\sum }_{k = 1}^{K} {W}_{k} {g}_{ij}^{k} ( t ) & ( Equation 17 )\end{matrix}$$

Here, Wₖ indicates the weight of the k-th transfer function. Weight Wₖ is determined based on the degree of similarity between the touch information obtained by the touch information obtaining unit 105 and the touch information corresponding to the k-th transfer function stored in the transfer function storage unit 106. For example, weight Wₖ is determined such that weight Wₖ increases as the degree in similarity increases. However, weight Wₖ must satisfy Equation 18.

$$\begin{matrix}[ Math 18 ] & \\ {\sum }_{k = 1}^{K} {W}_{k} = 1 & ( Equation 18 )\end{matrix}$$

For example, when the touch information is a value of load applied to the touch position, the degree of similarity of the touch information can be defined by an inverse of the load value difference. Weight Wₖ is not limited to this example, and is only required to be determined based on the degree of similarity. Moreover, weight Wₖ may be a constant value.

Moreover, for example, when a transfer function is interpolated in the frequency domain, the transfer function interpolation unit 211 can interpolate a transfer function using Equation 19.

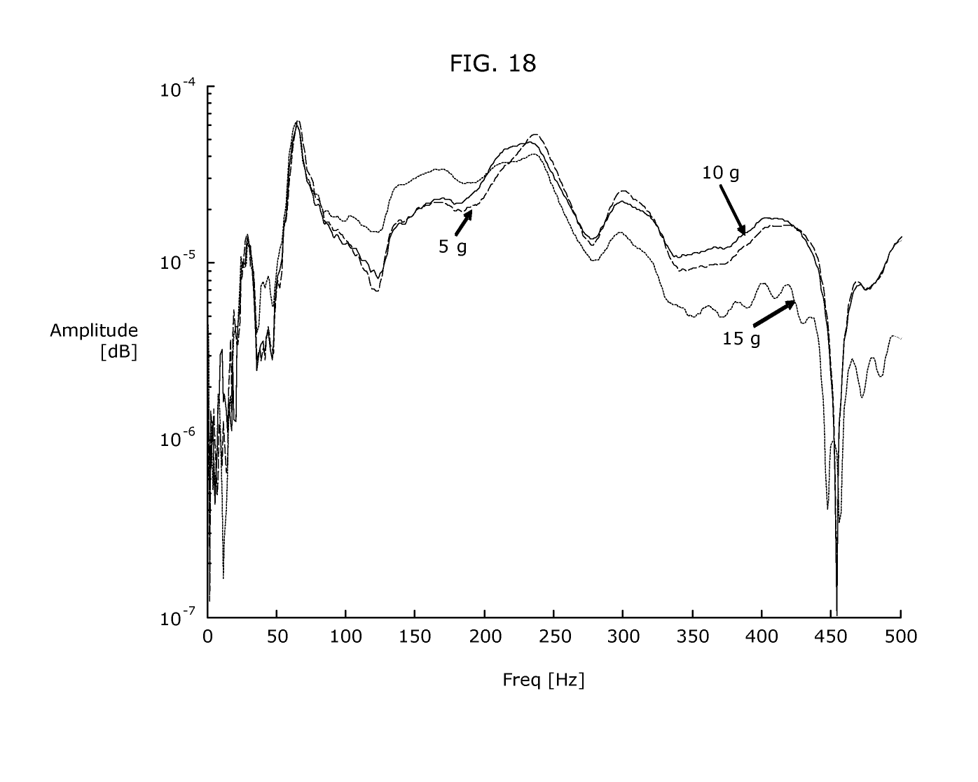

FIG. 18 illustrates one example of a transfer function interpolated by the transfer function interpolation unit 211. More specifically, FIG. 18 illustrates the result of interpolating a transfer function for when a load of 10 g is applied, from transfer functions when loads of 5 g and 15 g are applied to touch positions,

$$\begin{matrix}[ Math 19 ] & \\ {G}_{ij} ( f ) = {\sum }_{k = 1}^{K} {W}_{k} {G}_{ij}^{k} ( f ) & ( Equation 19 )\end{matrix}$$

Here, Wₖ indicates the weight of the k-th transfer function. Weight Wₖ is determined based on the degree of similarity between the touch information obtained by the touch information obtaining unit 105 and the touch information corresponding to the k-th transfer function obtained from the transfer function storage unit 106. For example, weight Wₖ is determined such that weight Wₖ increases as the degree of similarity increases. However, Wₖ must satisfy Equation 18.

Moreover, for example, when a transfer function is interpolated in the frequency domain, the transfer function interpolation unit 211 may interpolate a transfer function corresponding to the obtained touch information using a polynomial obtained by polynomial approximation using (i) an amplitude and phase of each frequency in the plurality of obtained transfer functions and (ii) a plurality of pieces of touch information similar to the obtained touch information. More specifically, using Equation 20 and 21, the transfer function interpolation unit 211 may calculate the amplitude Rᵢⱼ and phase Aᵢⱼ of each frequency in the transfer functions corresponding to the load values obtained by the touch information obtaining unit 105. Equation 20 and 21 are approximation functions which approximate by P-order polynomials of the amplitude and phase of the plurality of transfer functions obtained from the transfer function storage unit 106, using the amplitude Rᵢⱼ and phase Aᵢⱼ of each frequency in the transfer functions corresponding to the load values obtained by the touch information obtaining unit 105. The transfer function interpolation unit 211 may calculate transfer function Gᵢⱼ with Equation 22, using the calculated amplitude Rᵢⱼ and phase Aᵢⱼ.

By interpolating a transfer function in this way, the transfer function interpolation unit 211 can perform interpolation suitable to each frequency, rather than just a simple linear interpolation, making it possible to interpolate a transfer function with high accuracy.

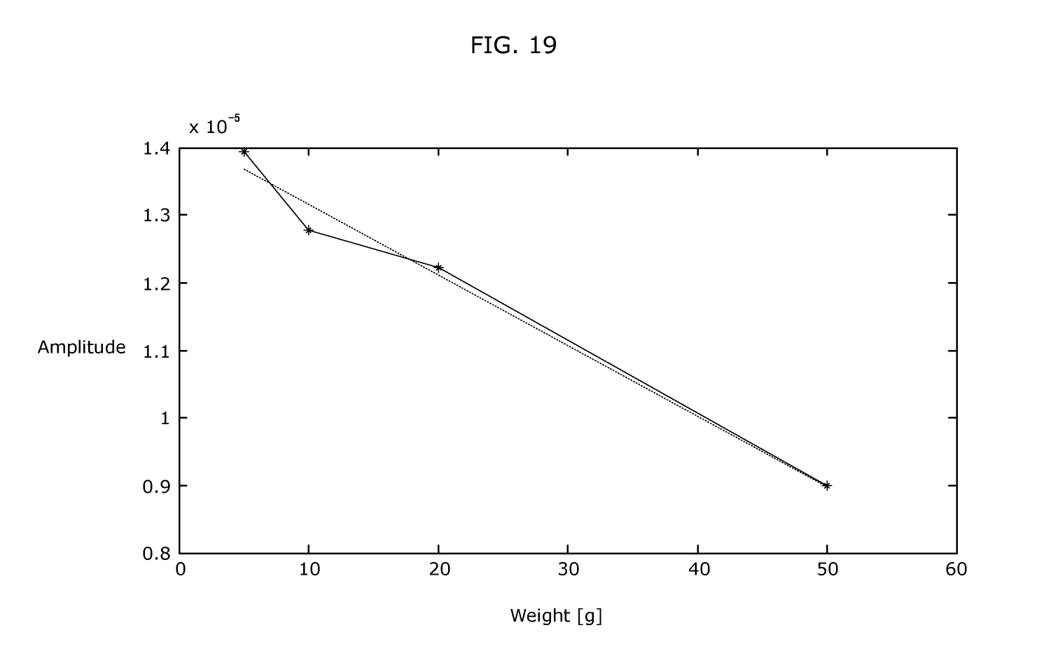

FIG. 19 illustrates the load characteristic (solid line) of a 200 Hz transfer function, and an approximated line when the load characteristic is approximated using a linear polynomial (dotted line). Performing this approximation on each frequency allows for detailed interpolation, not just a simple linear approximation.

It should be noted that in Embodiment 2, although polynomial approximation is used, linear approximation which uses a value in the vicinity of the load value may be used. Moreover, a different interpolation method may be used, such as spline interpolation.

$$\begin{matrix}[ Math 20 ] & \\ {R}_{ij} ( f ) = {\sum }_{p = 0}^{P} {C}_{p}^{R} \cdot {f}^{p} & ( Equation 20 ) \\ [ Math 21 ] & \\ {A}_{ij} ( f ) = {\sum }_{p = 0}^{P} {C}_{p}^{A} \cdot {f}^{p} & ( Equation 21 ) \\ [ Math 22 ] & \\ {G}_{ij} ( f ) = {R}_{ij} ( f ) exp ( {A}_{ij} ( f ) ) & ( Equation 22 )\end{matrix}$$

As described above, even when a transfer function corresponding to the touch information (for example, a load value) is not stored in the transfer function storage unit 106, the transfer function interpolation unit 211 can interpolate a transfer function corresponding to the touch information from transfer functions corresponding to touch information similar to that touch information.

[Haptic Feedback Device Operations]

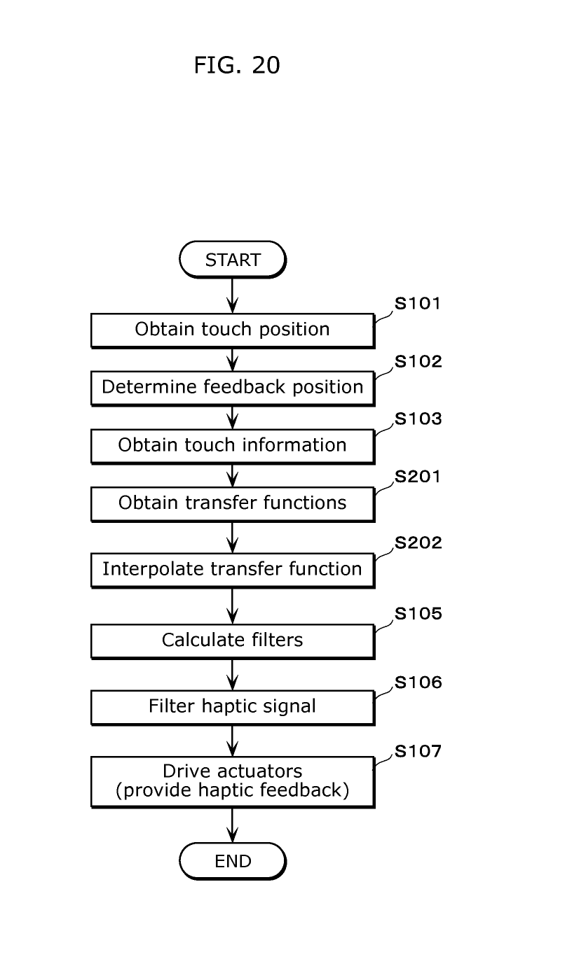

Next, specific examples of operations performed by the haptic feedback device having the above-described configuration will be described with reference to FIG. 20.

FIG. 20 is a flow chart illustrating operations performed by the haptic feedback device 200 according to Embodiment 2. It should be noted that in FIG. 20, the steps that are the same as those in FIG. 9 share the same reference numerals, and as such, explanations thereof are omitted.

(Step S201)

The transfer function obtaining unit 207 obtains a plurality of transfer functions corresponding to a plurality of pieces of touch information similar to the touch information obtained in step S103.

(Step S202)

The transfer function interpolation unit 211 interpolates a transfer function corresponding to the touch information obtained in step S103, from the plurality of transfer functions obtained in step S201. More specifically, the transfer function interpolation unit 211, for example, generates a transfer function corresponding to the touch information obtained by the touch information obtaining unit 105 by interpolation using Equation 18 or Equation 21.

### Advantageous Effect

As described above, with the haptic feedback device 200 according to Embodiment 2, it is possible to interpolate a transfer function corresponding to obtained touch information using a plurality of transfer functions corresponding to a plurality of pieces of touch information similar to the obtained touch information. Consequently, when the haptic feedback device 200 cannot obtain, from the transfer function storage unit 106, a transfer function corresponding to obtained touch information, the haptic feedback device 200 can obtain a transfer function suitable for the obtained touch information by interpolation. In other words, since the haptic feedback device 200 is capable of obtaining a more accurate transfer function, it is possible to provide even more suitable haptic feedback. Moreover, the haptic feedback device 200 is capable of reducing the number of transfer functions stored in advance in the transfer function storage unit 106, thereby making it possible to reduce the storage space required to store the transfer functions. As such, the haptic feedback device 200 can even be used in devices with memory having a low storage capacity such as smart phones or tablet computers.

### Other Embodiments

The herein disclosed subject matter is to be considered descriptive and illustrative only, and the appended Claims are of a scope intended to cover and encompass not only the particular embodiments disclosed, but also equivalent structures, methods, and/or uses.

For example, in each of the embodiments described above, haptic feedback is not provided at the second touch position (non-feedback position), but haptic feedback may be provided at the second touch position. In other words, it is sufficient so long as the haptic feedback at the second touch position is kept to a degree smaller than the haptic feedback provided at the first touch position (feedback position). That is, it is sufficient so long as vibration of the panel at the second touch position is less than the vibration of the panel at the first touch position. Even in this case, the haptic feedback device can provide stronger haptic feedback at the first touch position than the second touch position, making it possible to minimize confusion of the user from haptic feedback. In other words, this allows the haptic feedback device to provide suitable haptic feedback.

It should be noted that in this case, the vibration amplitude of the panel 101 at the second touch position is desirably half, and even more desirably one-tenth of the vibration amplitude of the panel 101 at a touch position requiring haptic feedback. With this, the haptic feedback device can further provide discernable haptic feedback at the first touch position and the second touch position, making it possible to further minimize confusion of the user from haptic feedback

It should be noted that since haptic feedback is not provided at the second touch position, driving signals for driving the actuators can be used that cause the vibration amplitude of the panel at the second touch position to be of a magnitude that is undetectable as haptic sensation by humans (for example, 1 μm or less).

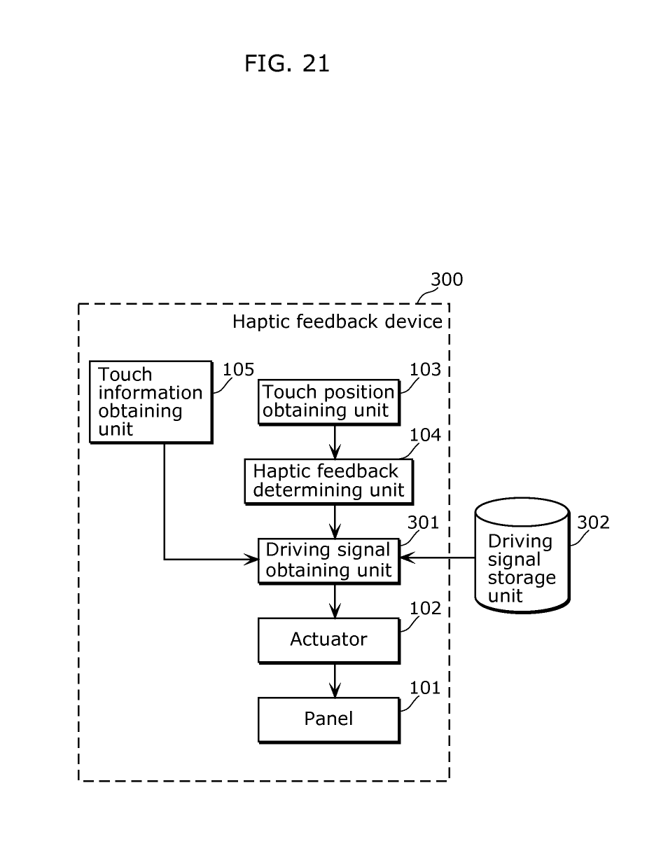

Moreover, in the above-described embodiments, the haptic feedback device is, as FIG. 21 illustrates, not required to include some of the structural components illustrated in FIG. 2 or FIG. 17. Moreover, the haptic feedback device may, as FIG. 21 illustrates, include structural components different from the structural components illustrated in FIG. 2 or FIG. 17.

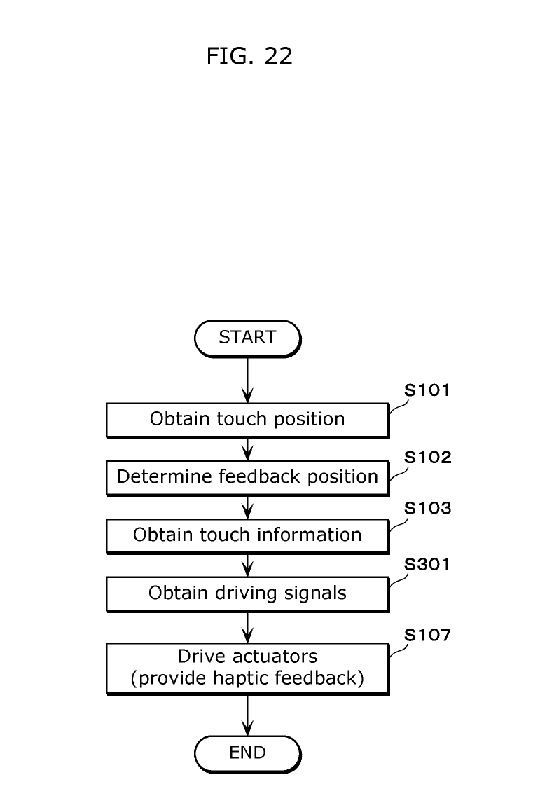

FIG. 21 illustrates the functional configuration of haptic feedback device 300 according to an embodiment. FIG. 22 is a flow chart illustrating operations performed by the haptic feedback device 300 according to an embodiment. In FIG. 21, the structural components that are the same as those in FIG. 2 share the same reference numerals, and as such, explanations thereof are omitted. Similarly, in FIG. 22, the steps that are the same as those in FIG. 9 share the same reference numerals, and as such, explanations thereof are omitted.

As is illustrated in FIG. 21, the haptic feedback device 300 includes the panel 101, the actuator 102, the touch position obtaining unit 103, the haptic feedback determining unit 104, the touch information obtaining unit 105, and a driving signal obtaining unit (processor) 301.

The driving signal obtaining unit 301 obtains, from a driving signal storage unit 302, driving signals for driving the plurality of actuators to vibrate the panel according to the haptic signal at the first touch position and vibrate the panel at a second touch position included in the plurality of touch positions more weakly than at the first touch position, the driving signals being generated using transfer functions of the panel from each of the plurality of actuators to the first touch position and the second touch position, the transfer functions corresponding to the touch information (S301).

The driving signal storage unit 302 stores a plurality of the driving signals for driving the actuators 102 in association with a plurality of combinations of a plurality of touch positions and pieces of touch information.

It is possible to obtain driving signals generated using transfer functions of the panel 101 corresponding to touch information with this haptic feedback device 300 as well. Consequently, the haptic feedback device 300 is capable of adjusting for variations in the transfer functions of the panel 101 caused by touches and vibrating the panel 101 accordingly, and thus capable of providing suitable haptic feedback for the multiple touches.

Each of the structural components in each of the above-described embodiments may be configured in the form of an exclusive hardware product, or may be realized by executing a software program suitable for the structural component. Each of the structural components may be realized by means of a program executing unit, such as a CPU and a processor, reading and executing the software program recorded on a recording medium such as a hard disk or a semiconductor memory. Here, the software program for realizing the haptic feedback device according to each of the embodiments is the program described below.

That is, the program causes the computer to execute a haptic feedback method including: detecting a plurality of touches in concurrent contact with the panel and detecting a plurality of positions, on the panel, of the plurality of touches; determining, from among the plurality of touch positions, a first touch position at which to provide haptic feedback by vibration according to a predetermined haptic signal; deriving touch information including at least one of state information indicating a state of the panel when the plurality of touches are detected or characteristic information indicating a characteristic of at least one of a plurality of objects touching the panel at the plurality of touch positions; generating driving signals for driving the plurality of actuators to vibrate the panel according to the haptic signal at the first touch position and vibrate the panel at a second touch position included in the plurality of touch positions more weakly than at the first touch position by using transfer functions of the panel from each of the plurality of actuators to the first touch position and the second touch position, the transfer functions corresponding to the touch information; and driving the plurality of actuators based on the driving signals.

### INDUSTRIAL APPLICABILITY

The haptic feedback device according to one or more exemplary embodiments disclosed herein is capable of providing mutually different haptic feedback for multiple touches, and as such is applicable in televisions, digital still cameras, digital movie cameras, personal computers, portable information devices and cellular phones which include a touch panel, for example. The haptic feedback device is also applicable to devices having a screen which a plurality of people touch at the same time, such as displays for digital blackboards and digital signs.

1. A haptic feedback device which provides haptic feedback to a user by vibrating a panel, the haptic feedback device comprising:
the panel;
a plurality of actuators placed at mutually different positions on the panel for vibrating the panel;
a detector that detects a plurality of touches in concurrent contact with the panel and detects a plurality of positions, on the panel, of the plurality of touches;
a processor that
derives touch information including at least one of state information indicating a state of the panel when the plurality of touches are detected or characteristic information indicating a characteristic of at least one of a plurality of objects touching the panel at the plurality of touch positions;
determines, from among the plurality of touch positions, a first touch position at which to provide haptic feedback by vibration according to a predetermined haptic signal; and
generates driving signals for driving the plurality of actuators to vibrate the panel according to the haptic signal at the first touch position and vibrate the panel at a second touch position included in the plurality of touch positions more weakly than at the first touch position by using transfer functions of the panel from each of the plurality of actuators to the first touch position and the second touch position, the transfer functions corresponding to the touch information,
wherein the plurality of actuators vibrate the panel based on the driving signals.

2. The haptic feedback device according to claim 1,
wherein the touch information includes load information indicating at least one of a plurality of loads applied to the panel at the plurality of touch positions.

3. The haptic feedback device according to claim 1,
wherein the touch information includes contact surface area information indicating at least one of a plurality of contact surface areas between the panel and the plurality of objects at the plurality of touch positions.

4. The haptic feedback device according to claim 1,
wherein the touch information includes hardness information indicating hardness of at least one of the plurality of objects touching the panel at the plurality of touch positions.

5. The haptic feedback device according to claim 1,
wherein the processor further
generates filters for filtering a given haptic signal to generate driving signals for driving the plurality of actuators to vibrate the panel at the first touch position according to the given haptic signal and not vibrate the panel at the second touch position by using the transfer functions,
wherein the driving signals are generated by filtering the haptic signal with the filters.

6. The haptic feedback device according to claim 5,
wherein the filters are generated so that a sum of convolution results, in a time domain, of first transfer functions included in the transfer functions and the filters indicates an impulse, and a sum of convolution results, in the time domain, of second transfer functions included in the transfer functions and the filters indicates zero, the first transfer functions indicating the transfer functions from each of the plurality of actuators to the first touch position and the second transfer functions indicating the transfer functions from each of the plurality of actuators to the second touch position.

7. The haptic feedback device according to claim 5,
wherein the filters are generated so that a sum of products, in a frequency domain, of first transfer functions included in the transfer functions and the filters indicates an impulse, and a sum of products, in the frequency domain, of second transfer functions included in the transfer functions and the filters indicates zero, the first transfer functions indicating the transfer functions from each of the plurality of actuators to the first touch position and the second transfer functions indicating the transfer functions from each of the plurality of actuators to the second touch position.

8. The haptic feedback device according to claim 5,
wherein the filters are generated by using the transfer functions corresponding to information associated with the second touch position among the touch information.

9. The haptic feedback device according to claim 5,
wherein the processor further:
derives a plurality of transfer functions respectively corresponding to a plurality of pieces of touch information similar to the derived touch information;
interpolates a transfer function corresponding to the derived touch information using the plurality of derived transfer functions; and
calculates the filters using the interpolated transfer function.

10. The haptic feedback device according to claim 9,
wherein the interpolated transfer function is interpolated using a linear combination of the plurality of derived transfer functions.

11. The haptic feedback device according to claim 9,
wherein the interpolated transfer function is interpolated by performing polynomial approximation using (i) an amplitude and a phase of each frequency in the plurality of derived transfer functions and (ii) the plurality of pieces of touch information similar to the derived touch information.

12. A haptic feedback method of providing haptic feedback to a user by vibrating a panel with a plurality of actuators placed at mutually different positions on the panel, the haptic feedback method comprising:
detecting a plurality of touches in concurrent contact with the panel and detecting a plurality of positions, on the panel, respectively of the plurality of touches;
determining, from among the plurality of touch positions, a first touch position at which to provide haptic feedback by vibration according to a predetermined haptic signal;
deriving touch information including at least one of state information indicating a state of the panel when the plurality of touches are detected or characteristic information indicating a characteristic of at least one of a plurality of objects touching the panel at the plurality of touch positions;
generating driving signals for driving the plurality of actuators to vibrate the panel according to the haptic signal at the first touch position and vibrate the panel at a second touch position included in the plurality of touch positions more weakly than at the first touch position by using transfer functions of the panel from each of the plurality of actuators to the first touch position and the second touch position, the transfer functions corresponding to the touch information; and
driving the plurality of actuators based on the driving signals.

13. A non-transitory computer-readable recording medium for use in a computer, the recording medium having a computer program recorded thereon for causing the computer to execute the haptic feedback method according to claim 12.
